(19) United States
(12) Patent Application Publication
(10) Pub. No.: US 2025/0378607 A1
(43) Pub. Date: Dec. 11, 2025

(54) TECHNIQUES FOR DISPLAYING TEXT

(71) Applicant: Apple Inc., Cupertino, CA (US)

(72) Inventors: Markus A. KOSKI, Vancouver, WA (US); Andrei IASHNEV, Vancouver (CA); Katherine E. FRAZER, Brooklyn, NY (US); Samuel W. FALCONER, San Jose, CA (US)

(21) Appl. No.: 19/169,629

(22) Filed: Apr. 3, 2025

Related U.S. Application Data
(60) Provisional application No. 63/657,902, filed on Jun. 9, 2024.

(51) Int. Cl. G06T 11/60; G06T 11/20

(52) U.S. Cl. CPC G06T 11/60; G06T 11/203; G06T 2210/12

(57) ABSTRACT

The present disclosure generally relates to displaying text. Some techniques are for displaying a text path in accordance with some embodiments. Other techniques are for outputting a text position in accordance with some embodiments.

### CROSS-REFERENCE TO RELATED APPLICATIONS

The present application claims priority to U.S. Provisional Patent Application Ser. No. 63/657,902, entitled “TECHNIQUES FOR DISPLAYING TEXT” filed Jun. 9, 2024, which is hereby incorporated by reference in its entirety for all purposes.

### FIELD

The present disclosure relates generally to computer user interfaces, and more specifically to techniques for displaying text.

### BACKGROUND

Text is often used to present ideas to people. However, techniques for displaying text have not been advancing lately. Accordingly, there is a need to enhance techniques for displaying text.

### SUMMARY

Some techniques for displaying text using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for displaying text. Such processes and interfaces optionally complement or replace other processes for displaying text. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more input devices and one or more display generation components is described. In some embodiments, the method comprises: while displaying, via the one or more display generation components, (1) a text box with a first set of one or more vertices and (2) a control point, detecting, via the one or more input devices, an input corresponding to the control point; in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: while displaying, via the one or more display generation components, (1) a text box with a first set of one or more vertices and (2) a control point, detecting, via the one or more input devices, an input corresponding to the control point; in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

In some embodiments, a transitory computer-readable storage medium storing one or more programs configured to be executed by one or more processors of a computer system that is in communication with one or more input devices and one or more display generation components is described. In some embodiments, the one or more programs includes instructions for: while displaying, via the one or more display generation components, (1) a text box with a first set of one or more vertices and (2) a control point, detecting, via the one or more input devices, an input corresponding to the control point; in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: while displaying, via the one or more display generation components, (1) a text box with a first set of one or more vertices and (2) a control point, detecting, via the one or more input devices, an input corresponding to the control point; in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

In some embodiments, a computer system configured to communicate with one or more input devices and one or more display generation components is described. In some embodiments, the computer system comprises means for performing each of the following steps: while displaying, via the one or more display generation components, (1) a text box with a first set of one or more vertices and (2) a control point, detecting, via the one or more input devices, an input corresponding to the control point; in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: while displaying, via the one or more display generation components, (1) a text box with a first set of one or more vertices and (2) a control point, detecting, via the one or more input devices, an input corresponding to the control point; in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

In some embodiments, a method that is performed at a computer system is described. In some embodiments, the method comprises: receiving an input corresponding to a request for an orientation of a character along a path; in response to receiving the input corresponding to the request for the orientation of the character along the path and in accordance with a determination that a first set of one or more criteria is satisfied: identifying, based on an average orientation of a first portion along the path, a first orientation for the character, wherein the first portion along the path is larger than a width of the character; and outputting an indication of the first orientation.

In some embodiments, a non-transitory computer-readable storage medium storing one or more programs configured to be executed by one or more processors of a computer system is described. In some embodiments, the one or more programs includes instructions for: receiving an input corresponding to a request for an orientation of a character along a path; in response to receiving the input corresponding to the request for the orientation of the character along the path and in accordance with a determination that a first set of one or more criteria is satisfied: identifying, based on an average orientation of a first portion along the path, a first orientation for the character, wherein the first portion along the path is larger than a width of the character; and outputting an indication of the first orientation.

In some embodiments, a transitory computer-readable storage medium storing one or more programs configured to be executed by one or more processors of a computer system is described. In some embodiments, the one or more programs includes instructions for: receiving an input corresponding to a request for an orientation of a character along a path; in response to receiving the input corresponding to the request for the orientation of the character along the path and in accordance with a determination that a first set of one or more criteria is satisfied: identifying, based on an average orientation of a first portion along the path, a first orientation for the character, wherein the first portion along the path is larger than a width of the character; and outputting an indication of the first orientation.

In some embodiments, a computer system is described. In some embodiments, the computer system comprises one or more processors and memory storing one or more programs configured to be executed by the one or more processors. In some embodiments, the one or more programs includes instructions for: receiving an input corresponding to a request for an orientation of a character along a path; in response to receiving the input corresponding to the request for the orientation of the character along the path and in accordance with a determination that a first set of one or more criteria is satisfied: identifying, based on an average orientation of a first portion along the path, a first orientation for the character, wherein the first portion along the path is larger than a width of the character; and outputting an indication of the first orientation.

In some embodiments, a computer system is described. In some embodiments, the computer system comprises means for performing each of the following steps: receiving an input corresponding to a request for an orientation of a character along a path; in response to receiving the input corresponding to the request for the orientation of the character along the path and in accordance with a determination that a first set of one or more criteria is satisfied: identifying, based on an average orientation of a first portion along the path, a first orientation for the character, wherein the first portion along the path is larger than a width of the character; and outputting an indication of the first orientation.

In some embodiments, a computer program product is described. In some embodiments, the computer program product comprises one or more programs configured to be executed by one or more processors of a computer system. In some embodiments, the one or more programs include instructions for: receiving an input corresponding to a request for an orientation of a character along a path; in response to receiving the input corresponding to the request for the orientation of the character along the path and in accordance with a determination that a first set of one or more criteria is satisfied: identifying, based on an average orientation of a first portion along the path, a first orientation for the character, wherein the first portion along the path is larger than a width of the character; and outputting an indication of the first orientation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for displaying text, thereby increasing the effectiveness, efficiency, and user satisfaction with such devices. Such processes and interfaces may complement or replace other processes for displaying text.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6N illustrate exemplary user interfaces for displaying text along a path in accordance with some embodiments.

FIG. 7 is a flow diagram illustrating a process for displaying a text path in accordance with some embodiments.

FIGS. 8A-8C illustrate exemplary user interfaces for calculating text position in accordance with some embodiments.

FIG. 9 is a flow diagram illustrating a process for outputting a text position in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for displaying text. For example, some techniques modify a number of vertices in a text box to change a shape of the text box. For another example, other techniques calculate an orientation of a character based on an average orientation of an area larger than the character. Such techniques can reduce the cognitive burden on a user who are using text, thereby enhancing productivity. Further, such techniques can reduce processor and battery power otherwise wasted on redundant user inputs.

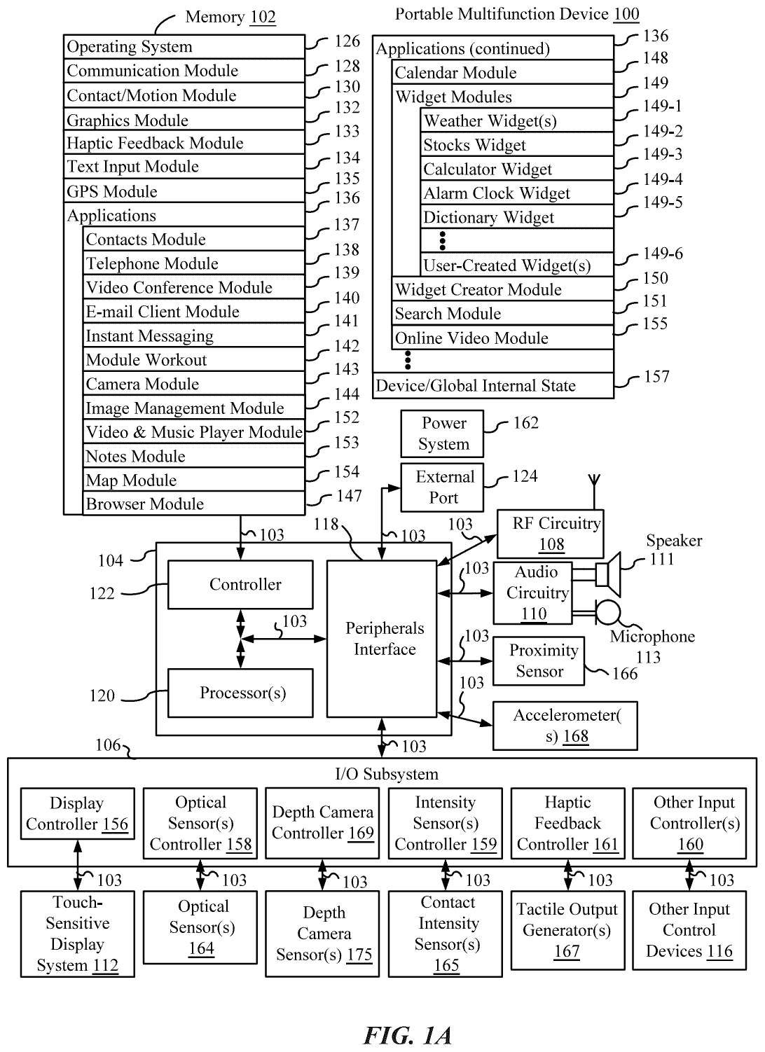

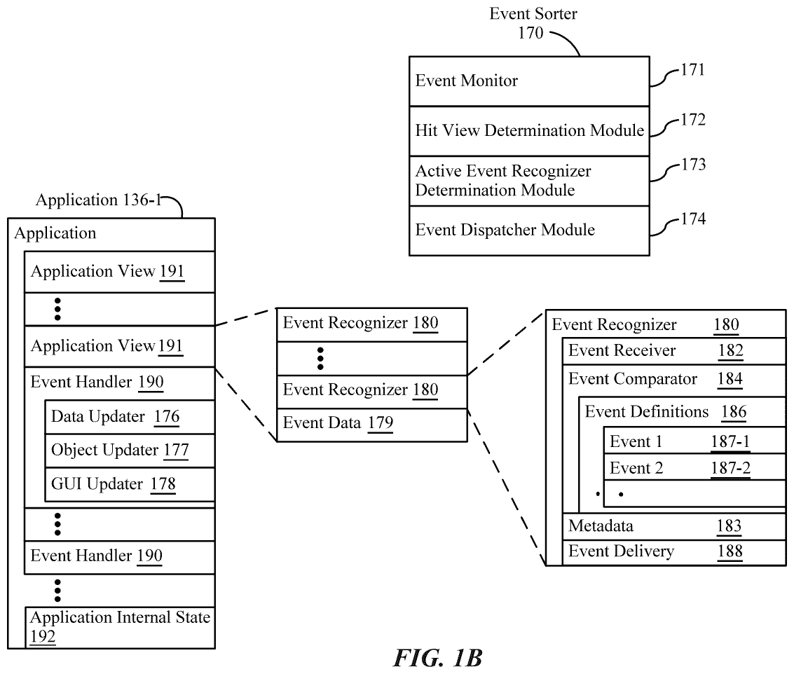

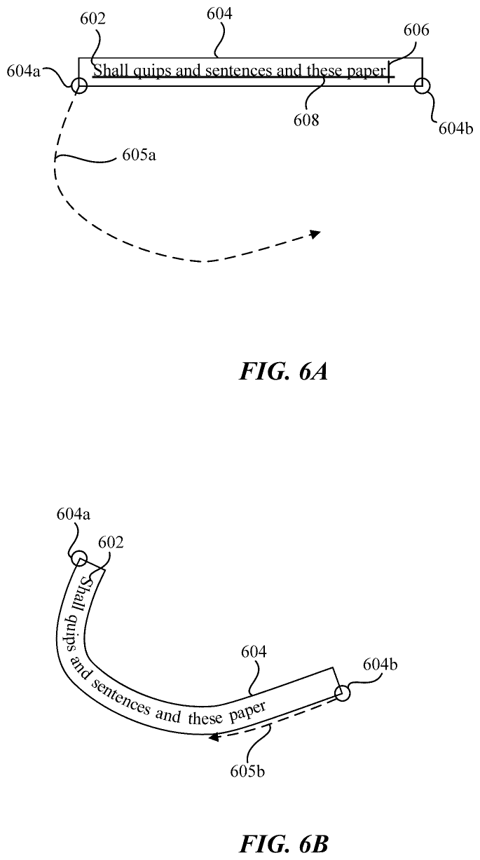

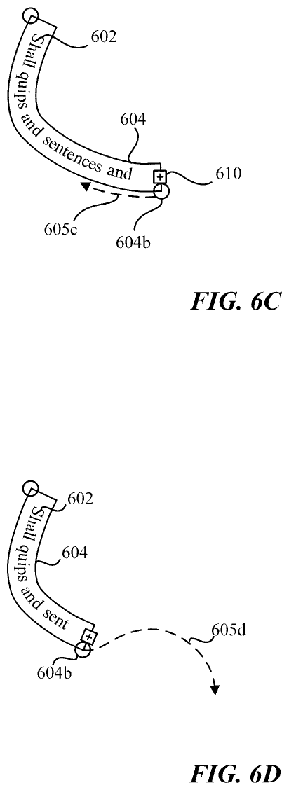

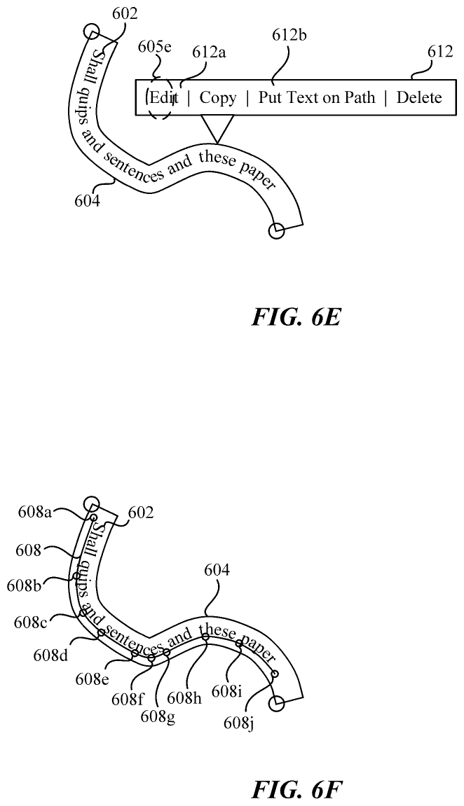

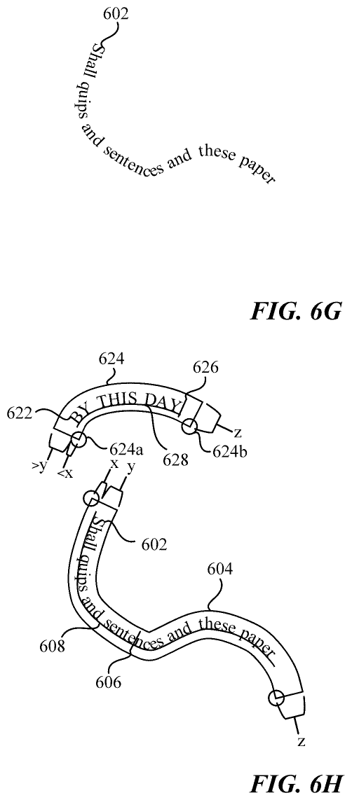

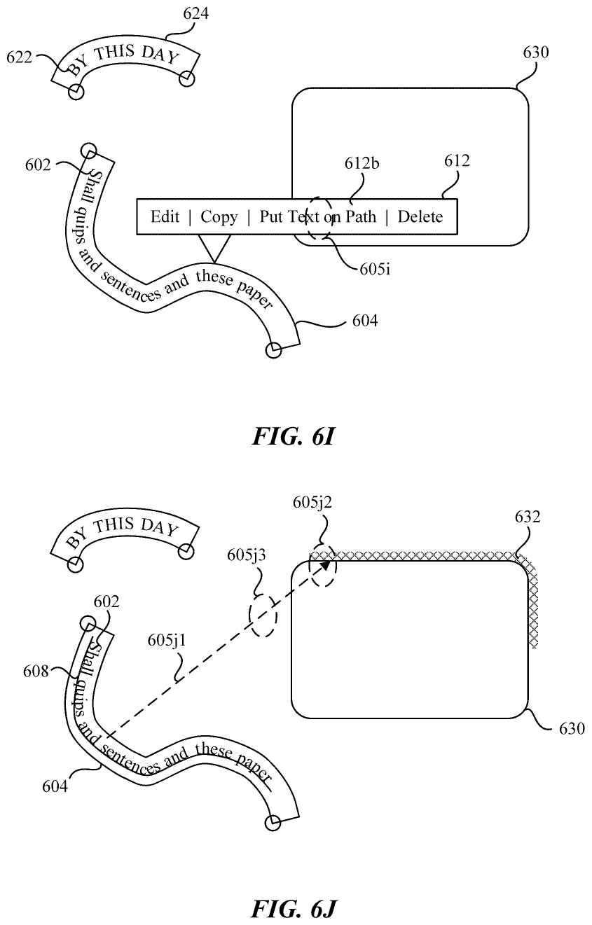

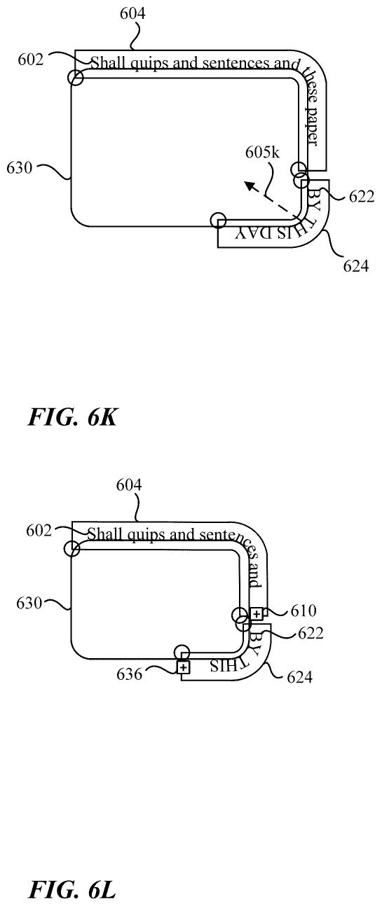

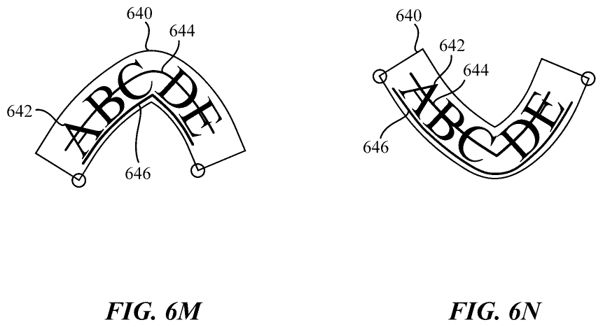

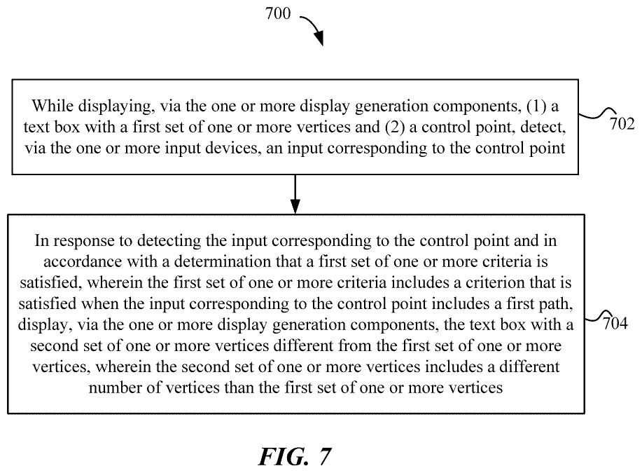

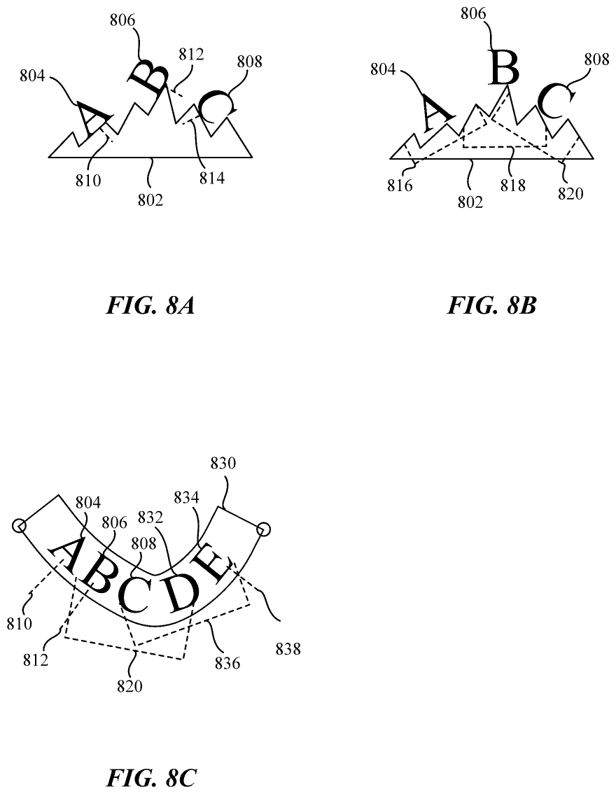

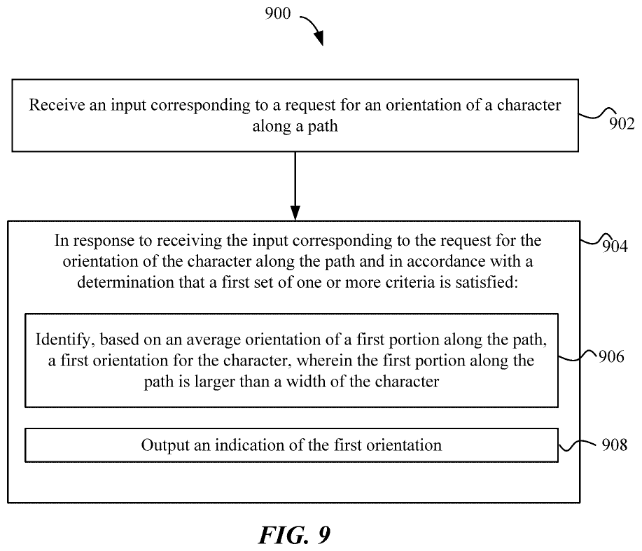

Below, FIGS. 1A-1B, 2, 3A-3G, 4A-4B, and 5A-5B provide a description of exemplary devices for performing the techniques for displaying text. FIGS. 6A-6N illustrate exemplary user interfaces for displaying text along a path in accordance with some embodiments. FIG. 7 is a flow diagram illustrating a process for displaying a text path in accordance with some embodiments. The user interfaces in FIGS. 6A-6N are used to illustrate the processes described below, including the processes in FIG. 7. FIGS. 8A-8C illustrate exemplary user interfaces for calculating text position in accordance with some embodiments. FIG. 9 is a flow diagram illustrating a process for outputting a text position in accordance with some embodiments. The user interfaces in FIGS. 8A-8C are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

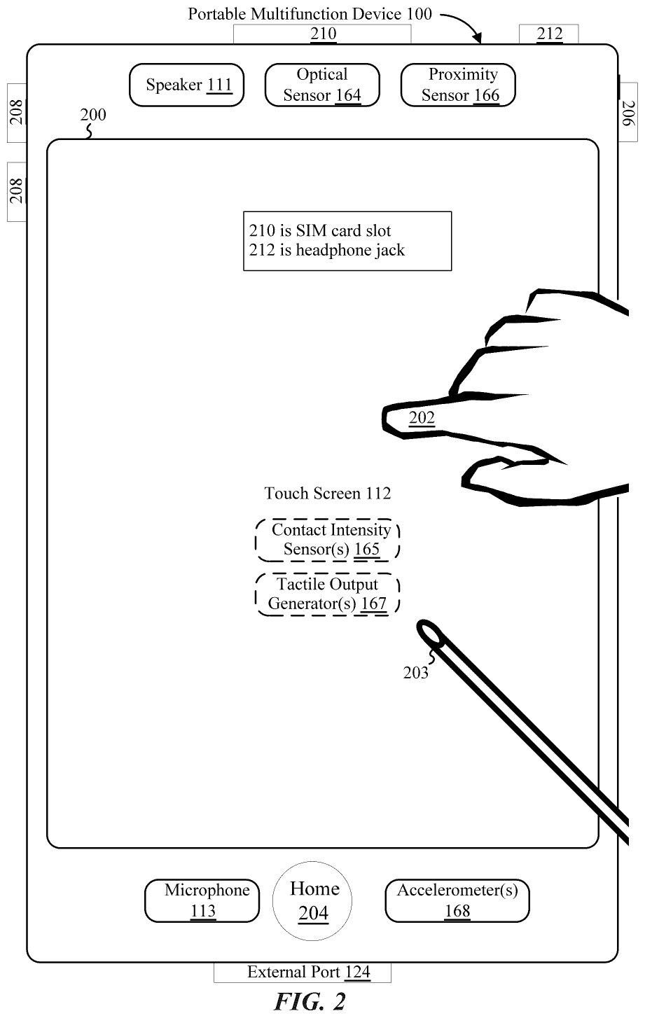

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

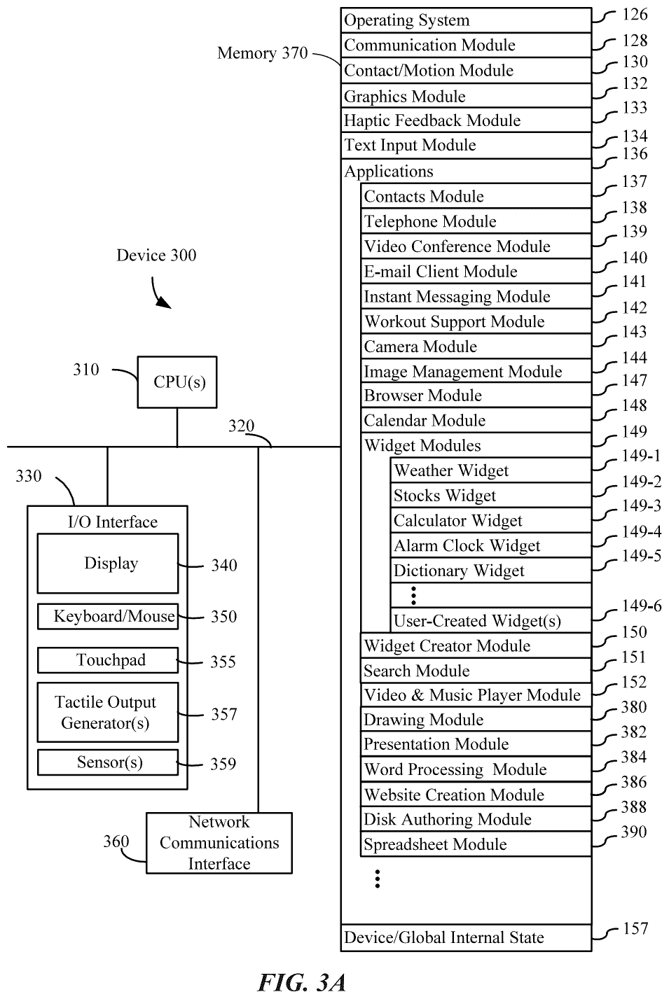

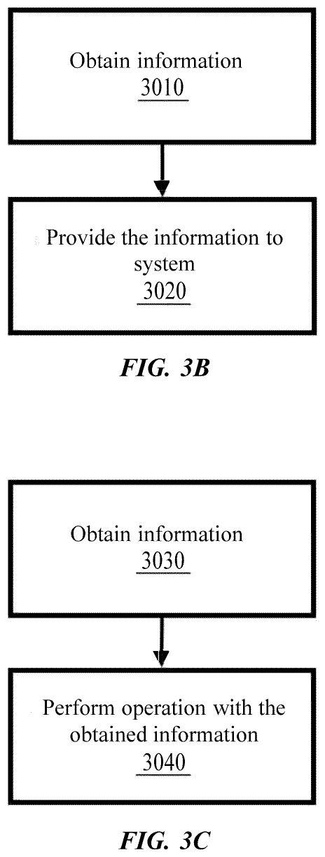

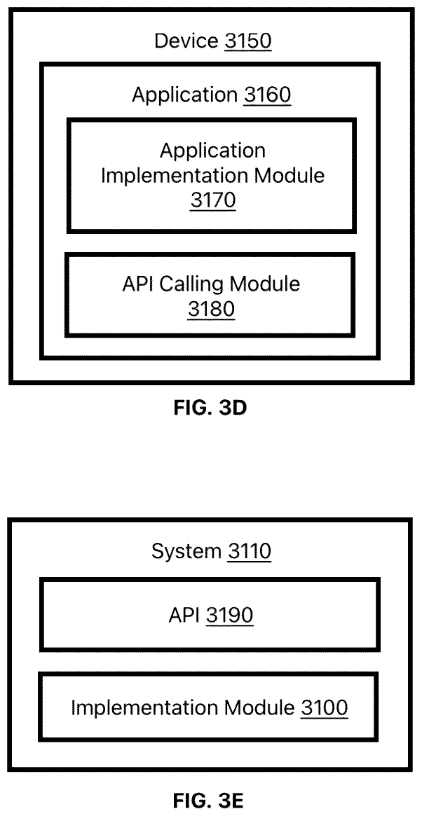

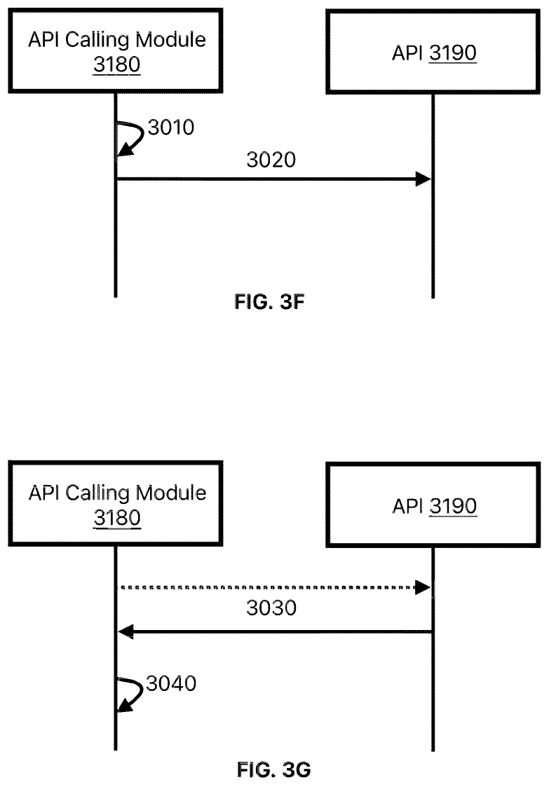

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and 900 (FIGS. 7 and 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

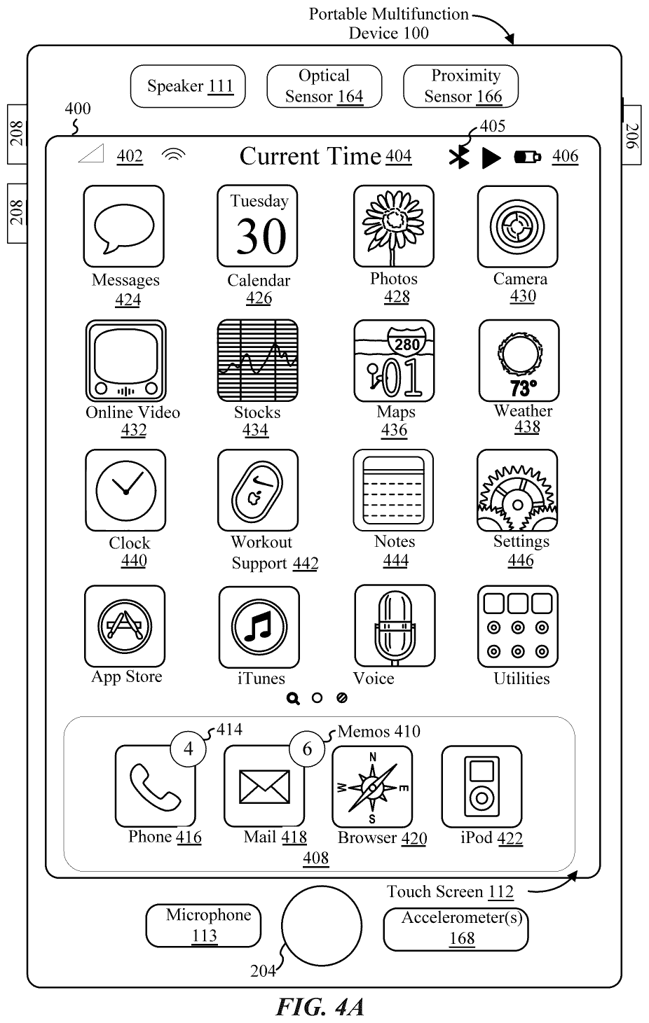

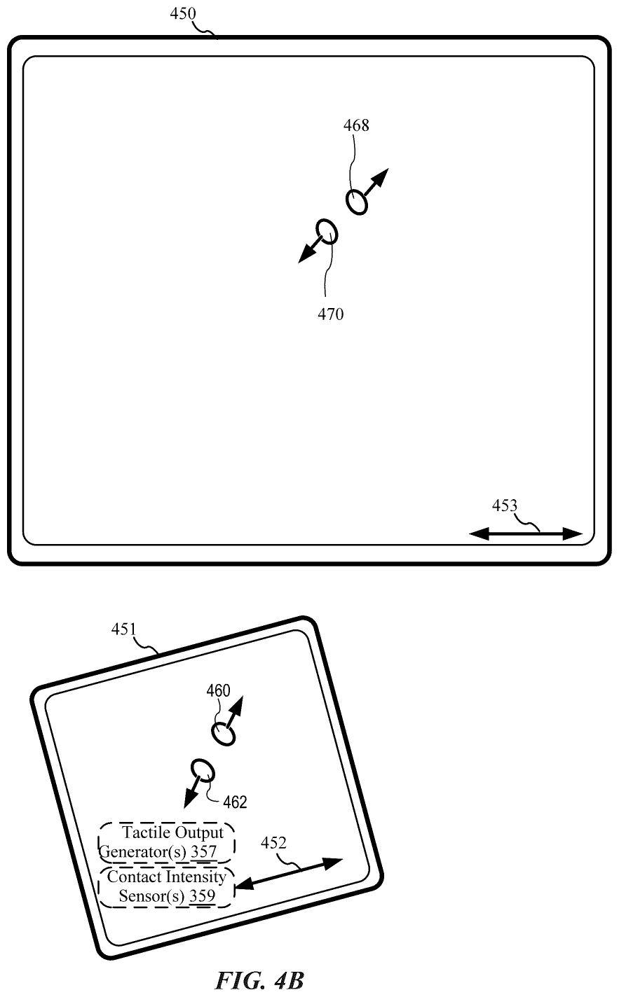

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

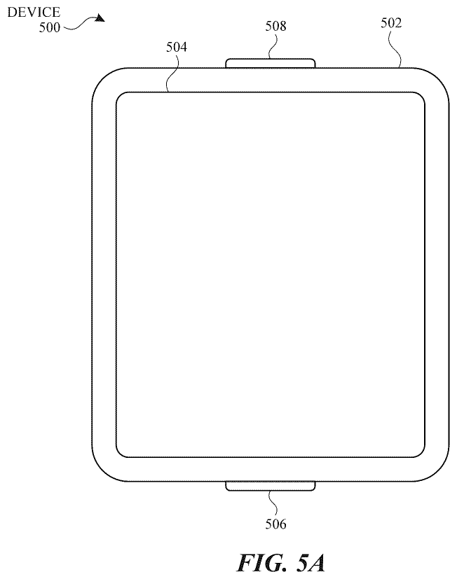

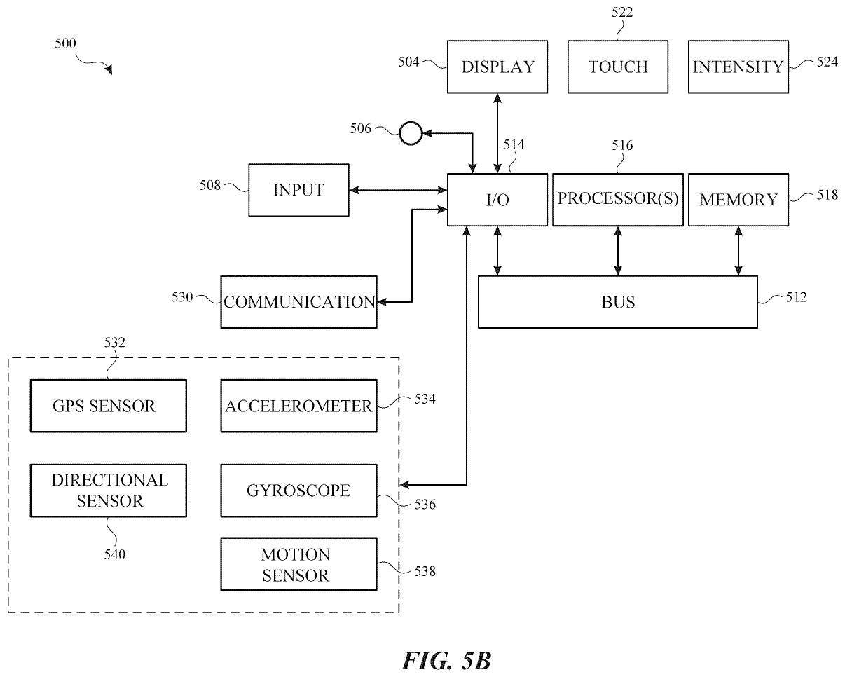

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6N illustrate exemplary processes for controlling text placement in accordance with some embodiments. The user interfaces in these figures are used to illustrate the processes described below, including the processes in FIGS. 7 and 9.

FIGS. 6A-6N illustrate text and user interface elements displayed by a computer system, such as a laptop with a keyboard and a touch sensitive display screen. It should be recognized that the text and user interface elements can be displayed by other types of computer systems, such as a smart phone, a tablet, a personal gaming system, a desktop computer, and/or a head-mounted display (HMD) device. In some embodiments, computer system 600 includes and/or is in communication with one or more input devices and/or sensors (e.g., a camera, a LiDAR sensor, a motion sensor, an infrared sensor, a microphone, a touch-sensitive surface, and/or a physical input mechanism such as a keyboard, a mouse, button, a rotational mechanism, and/or a slider). Such sensors can be used to detect presence of, attention of, statements from, inputs corresponding to, requests from, and/or instructions from a user in an environment. It should be recognized that, while some embodiments described herein refer to inputs being touch inputs detected via a touch-sensitive surface, other types of inputs can be used with techniques described herein, such as voice inputs that are detected via one or more microphones and/or air gestures detected via a camera that is in communication (e.g., wireless and/or wired communication) with the computer system.

FIGS. 6A-6L illustrate processes for manipulating a shape of a text box. In these processes, manipulating the shape of the text box manipulates the shape of a baseline within the text box. As text within the text box follows the baseline, the shape of the baseline affects the layout of the text within the text box. Please note that while referring to the top, bottom, left, and/or right of text boxes within this document, these directions are determined by and relative to an orientation of the text within the text box. For example, if the text is right side up, the top of the text box is above the text, the right side, the right end, and the right edge of the text box is to the right of the last character of the text, the bottom of the text box is below the text, and the left side, left end, and left edge of the text box is to the left of the first character of the text. For another example, if the text is upside down, the bottom of the text box is above the text, the right side, the right end, and the right edge of the text box is to the left of the last character of the text, the top of the text box is below the text, and the left side, left end, and left edge of the text box is to the right of the first character of the text.

In some embodiments, a vertex is a joining point of two lines or curves. In such embodiments, the computer system can manipulate a shape of the text box by increasing or decreasing a number of vertices within the text box. For example, when increasing an amount of curve in the text box, the computer system can add one or more vertices to the text box and/or to the baseline within the text box to create the increased curve of the text box. For another example, when decreasing an amount of curve in the text box, the computer system can remove one or more vertices within the text box and/or baseline within the text box to decrease an amount of curve of the text box.

As illustrated in FIG. 6A, the computer system displays first text box 604 with first text 602, which includes seven words “Shall quips and sentences and these paper”. It should be recognized that first text 602 can include more, fewer, and/or different words than illustrated. In some embodiments, first text 602 includes one or more letters and/or one or more symbols.

As illustrated in FIG. 6A, the computer system displays first text 602 with first edit cursor 606, indicating that first text 602 is in a state to be edited. As illustrated in FIG. 6A, in response to first text 602 being in a state to be edited, the computer system displays first baseline 608 within first text box 604 between first text 602 and the bottom of first text box 604. In some embodiments, the computer system displays first baseline 608 in a different color and/or opacity to first text 602 to aid the user in distinguishing first baseline 608 as part of first text 602 (e.g., an underline and/or an artistic feature of the font).

As illustrated in FIG. 6A, first text box 604 includes first left control point 604a in the bottom left corner of first text box 604 and first right control point 604b the bottom right corner of first text box 604. It should be recognized that such controls can be located in different locations in some embodiments. At FIG. 6A, the computer system detects selection input 605a as a select-and-drag input starting at first left control point 604a and moving in a curving motion that starts moving down and to the left and changes to moving to the right and up.

As illustrated in FIG. 6B, in response to detecting selection input 605a, the computer system displays first text box 604 in a shape of a curve that follows the curve created by the selection input 605a. As illustrated in FIG. 6B, as part of changing the shape of first text box 604, the computer system alters the position of the characters of first text 602 while keeping first text 602 within first text box 604. The computer system altering the position of the characters of first text 602 includes moving and/or rotating the characters. In some embodiments, based on the shape of first text box 604, the computer system displays the same character at different locations within first text box 604 in different orientations. As illustrated in FIG. 6B, in response to the curved shape of first text box 604, the computer system displays the character “a” within the first word “Shall” of first text 602 in as sideways and the computer system displays the character “a” within the seventh word “paper” of first text 602 as mostly right side up. In some embodiments, based on the shape of first text box 604, the computer system displays the same character at different locations within first text box 604 in the same orientation. As illustrated earlier in FIG. 6A, in response to the shape of first text box 604 being a straight rectangle, the computer system displays all of the characters “a” within first text 602 as right side up.

In some embodiments, the computer system does not display first baseline 608 when the text is not currently being edited or moved. Accordingly, at FIG. 6B, the computer system does not display baseline 608. In such embodiments, the computer system can display first baseline 608 while the shape of first text box 604 is being edited (e.g., while the computer system detects selection input 605a). Please note that the computer system did not change the location of first left control point 604a in response to detecting selection input 605a, but the location of first right control point 604b changed to accommodate the new shape and position of first text box 604. In some embodiments, the location of first left control point 604a does change as a result of selection input 605a initially moving left or up. Please also note that the computer system did not change the length of first text box 604 in response to detecting selection input 605a. In some embodiments, the computer system does change the length of first text box 604 in response to detecting selection input 605a. For example, if the computer system detects selection input 605a terminate before extending for at least a length of first text box 604, the computer system can display first text box 604 with a length as long as selection input 605a. For another example, if the computer system detects selection input 605a as continuing beyond the original length of first text box 604, the computer system can display first text box 604 with the new longer length (e.g., extending with no content and/or text in the new longer length). As described above, the computer system manipulating the shape of first text box 604 to change first text box 604 from a straight rectangle to a curved shape includes the computer system adding one or more vertices to first text box 604 to accommodate the curved shape.

In some embodiments, the computer system changes the shape of first text box 604 while detecting selection input 605a. In some embodiments, the computer system redisplays first text box 604 with the new shape after and/or in response to detecting the release of selection input 605a. At FIG. 6B, the computer system detects selection input 605b as a select-and-drag input starting at bottom first right control point 604b and following to the left along the bottom edge of first text box 604 and ending halfway under the sixth word in first text 602 (e.g., “these”).

As illustrated in FIG. 6C, in response to detecting selection input 605b, the computer system displays first text box 604 with less length than the computer system displayed first text box 604 in FIG. 6B. The computer system manipulating the shape of first text box 604 to change first text box 604 to have less length while not changing the curvature includes the computer system removing one or more vertices from first text box 604, specifically from the area of first text box 604 that is no longer displayed as those vertices are no longer needed. The computer system does not move those vertices to the still existing section first text box 604.

As part of displaying first text box 604 with less length, the computer system displays fewer characters and/or words of first text 602 within first text box 604. As illustrated in FIG. 6C, in response to selection input 605b ending halfway under the sixth word in first text 602, the computer system continues to display the first five words of first text 602 and ceases displaying the last two words of first text 602. As illustrated in FIG. 6C, in response to ceasing to display some of the characters and/or words of first text 602, the computer system displays first additional content indicator 610 at the right edge of first text box 604 to indicate that there is more content for first text 602 that is not shown within first text box 604. At FIG. 6C, the computer system detects selection input 605c as a select-and-drag input starting first right control point 604b and following to the left along the bottom edge of first text box 604 and ending halfway under the fourth word in first text 602.

As illustrated in FIG. 6D, in response to detecting selection input 605c, the computer system displays first text box 604 with less length than the computer system displayed first text box 604 in FIG. 6C. As part of displaying first text box 604 with less length, the computer system again removes one or more vertices from first text box 604 and the computer system displays fewer characters within first text box 604. As illustrated in FIG. 6D, in response to selection input 605c ending halfway under the fourth word in first text 602, the computer system continues to display the first three words and the first half of the fourth word of first text 602 while ceasing to display the second half of the fourth word as well as the last three words of first text 602. Please note how this is different from how the computer system ceases display of all of the sixth word in first text 602 in response to detecting selection input 605b ending halfway under the sixth word in first text 602. In some embodiments, in response to a word having over a predetermined number of characters, the computer system ceases displaying a portion of the word instead of the entire word as part of decreasing the length of first text box 604.

In some embodiments, when ceasing to display characters of the first text 602 as part of displaying first text box 604 with less length, the computer system removes the text word by word until a predetermined number of characters remain, at which point the computer system removes the text character by character as the length of first text box 604 is decreased. For example, if a determination is made that there are less than twenty characters left in the text after the computer system has ceased to display the previous word, the computer system will cease display of the text character by character as first text box 604 decreases in length. In some embodiments, the speed with at which the computer system (e.g., the speed of the detected select-and-drag inputs) decreases the length of first text box 604 determines if the computer system removes the text word by word or character by character. For example, if the computer system decreases the length of first text box 604 quickly, the computer system removes the text word by word, and if the computer system decreases the length of first text box 604 slowly the computer system removes the text character by character. In some embodiments, the computer system ceases display of characters starting at the beginning of first text 602 instead of the end of first text 602 when ceasing to display characters and/or words as part of decreasing the length of first text box 604. For example, the computer system ceases to display the words “Shall quips” instead of “these paper” at FIG. 6C. At FIG. 6D, the computer system detects selection input 605d as a drag input starting at first right control point 604b moving away from first text box 604 and curving to the right and down.

As illustrated in FIG. 6E, in response to detecting selection input 605d, the computer system increases the length of first text box 604 in a curve following the path of selection input 605d. As part of the computer system increasing the length of first text box 604, the computer system adds one or more vertices to first text box 604 to accommodate the increased length and the added curvature of first text box 604. As illustrated in FIG. 6E, as part of the computer system expanding the length of first text box 604, the computer system displays all seven of the words comprising first text 602 within first text box 204. At FIG. 6E, in response to the computer system displaying all the words of first text 602 the computer system ceases display of first additional content indicator 610. Please note that while increasing the length of first text box 604, the computer system does not alter how the already displayed portion of first text box 604 is displayed. As illustrated, in FIG. 6E, the computer system continues to display the portion of first text box 604 that includes the characters “Shall quips and sent” as the computer system did in FIG. 6D while also displaying the new expanded portion of first text box 604 that contains the characters “ences and these paper”.

At FIG. 6E, the computer system detects a selection input that results in the computer system displaying edit menu 612 corresponding to first text box 604. As illustrated in FIG. 6E, edit menu 612 includes controls that when selected copy, delete, alter, or create an opportunity to alter text. For example, the controls include edit control 612a and text on path control 612b. At FIG. 6E, the computer system detects selection input 605e as a tap at a location corresponding to edit control 612a.

At FIG. 6F, in response to detecting selection input 605e, the computer system ceases display of edit menu 612. As illustrated in FIG. 6F, in response to detecting selection input 605e, the computer system displays first baseline 608 and the vertices of first baseline 608, which include first vertex 608a, second vertex 608b, third vertex 608c, fourth vertex 608d, fifth vertex 608e, six vertex 608f, seventh vertex 608g, eighth vertex 608h, ninth vertex 608i, and tenth vertex 608j. In some embodiments, first baseline 608 has more or less than ten vertices. In some embodiments, the computer system detects one or more selection inputs as select-and-drag inputs at locations corresponding to one or more of the vertices resulting in the computer system moving position of the one or more vertices. In such embodiments, the computer system moving the position of the one or more vertices includes the computer system moving the position of the baseline, the text, and the text box to correspond to the new positions of the vertices.

In some embodiments, the computer system maintains a constant spacing above and below first baseline 608 within first text box 604, even during manipulations. For example, while the computer system manipulates the shape of first text box 604 via selection inputs starting on locations corresponding to a vertex and/or selection inputs starting on locations corresponding to first left control point and/or first right control point, the computer system maintains the distance between the top of first text box 604 and first baseline 608 and the distance between the bottom of first text box 604 and first baseline 608. At FIG. 6F, the computer system detects a selection input that deselects first text 602.

At FIG. 6G, in response to first text 602 being deselected, the computer system displays first text 602 without first text box 604, first baseline 608, the vertices, left control point 604a, and right control point 604b. As illustrated in FIG. 6G, the computer system continues to display first text 602 in the same position as the computer system displays first text 602 in FIG. 6F. In some embodiments, first text box 604, first baseline 608, and the vertices are still present and affecting first text 602 while the computer system is not displaying first text box 604, first baseline 608, and the vertices.

At FIG. 6H, the computer system detects selection inputs that include inputting second text 622 via the keyboard followed by the computer system detecting a selection input similar to the one described above with respect to FIG. 6B manipulating the now displayed text. As illustrated in FIG. 6H, in response to detecting the selection inputs inputting and manipulating the displayed text, the computer system displays second text 622 as curved within curved second text box 624. As illustrated in FIG. 6H, second text box 624 includes second left control point 624a in the bottom left corner of second text box 624 and second right control point 624b in the bottom right corner of second text box 624, just like first text box 604 and first left control point 604a and first right control point 604b. As illustrated in FIG. 6H, the computer system displays second text 622 with second edit cursor 626 indicating that second text 622 is in a state to be edited, and, in response to second text 622 being in a state to be edited, the computer system displays second baseline 628 within second text box 624 between second text 622 and the bottom of second text box 624.

For demonstration purposes, FIG. 6H illustrates the computer system also displaying first text 602 in a state to be edited with first edit cursor 606 and first baseline 608. In some embodiments, the computer system does not display first text 602 in a state to be edited (e.g., with first edit cursor 606 and first baseline 608) while the computer system displays second text 622 in a state to be edited (e.g., with second edit cursor 626 and second baseline 628). In some embodiments, the computer system does not display second text 622 in a state to be edited while the computer system displays first text 602 in a state to be edited.

As illustrated in FIG. 6H, first text box 604 and second text box 624 are the same height of z. As illustrated in FIG. 6H, second text 622 is the same font and the same font size as first text 602 with the difference of second text 622 being all capital letters. As illustrated in FIG. 6H, in response to displaying second text 622 being all capital letters and first text 602 being capital and lowercase letters, the computer system displays second baseline 628 at a different position within second text box 624 than the computer system displays first baseline 608 within first text box 604. As illustrated in FIG. 6H, second baseline 628 is closer to the bottom of second text box 624 (e.g., <x) than first baseline 608 is to the bottom of first text box 604 (e.g., x).

As illustrated in FIG. 6I, the computer system displays shape 630. In some embodiments, the computer system displays shape 630 in response to detecting a series of selection inputs to drag-and-drop the shape next to first text 602 and second text 622. At FIG. 6I, the computer system detects a selection input that results in the computer system displaying edit menu 612 corresponding to first text box 604. At FIG. 6I, the computer system detects selection input 605i as a tap at a location corresponding to text on path control 612b.

At FIG. 6J, in response to detecting selection input 605i, the computer system ceases display of edit menu 612. At FIG. 6J, the computer system detects selection input 605j1 as a drag starting at point corresponding to first text box 604 and moving towards the upper edge of shape 630. At FIG. 6J, the computer system detects selection input 605j1 at upper release point 605j2 near the upper edge of shape 630. As illustrated in FIG. 6J, in response to detecting selection input 605j1 at upper release point 605j2 after detecting selection input 605i, the computer system highlights snap area 632 outside the edge of shape 630 to mark the area that first text 602 will snap to when selection input 605j1 is released at upper release point 605j2. In some embodiments, the computer system detects selection input 605j1 at lower release point 605j3 at a point near the left side of shape 630 while detecting selection input 605j1 moving toward upper release point 605j2 after detecting selection input 605i. In such embodiments, the computer system highlights an area outside the edge of shape 630 near lower release point 605j3 that first text 602 will snap to when selection input 605j1 is released at lower release point 605j3. For example, the computer system highlights the area along the left edge and around to the top left corner and some of the top edge of shape 630 to indicate to the user the snapping location for first text if selection input 6905j1 is ended at lower release point 605j3. In some embodiments, the computer system ceases highlight of the area that first text 602 will snap to when the computer system no longer detects selection input 6051 near the highlighted area. For example, as the computer system detects selection input 6051 move past lower release point 605j3 towards upper release point 605j2, the computer system ceases highlight of the area near lower release point 605j3 and highlights snap area 632.

At FIG. 6J, in response to detecting selecting input 605j1, the computer system moves first text 602, first text box 604, first left control point 604a, and first right control point 604b as a unit along the line created by selection in put 605j1. As illustrated in FIG. 6J, as part of moving first text 602, the computer system displays first baseline 608 and moves first baseline 608 with first text 602. At FIG. 6J, the computer system detects release of selecting input 605j1 at upper release point 605j2. At FIG. 6J, the computer system detects similar inputs as described above with respect to FIGS. 6I-6J at locations corresponding to second text box 624 and the bottom corner of shape 630.

As illustrated in FIG. 6K, in response to detecting the release of selecting input 605j1 at upper release point 605j2, the computer system displays first text 602 at snap area 632 which was highlighted in FIG. 6J. As illustrated in FIG. 6K, in response to similar inputs as described above with respect to FIGS. 6I-6J corresponding to second text box 624, the computer system displays second text box 624 as following the outer edge of the bottom right corner of shape 630. The process of snapping a text (e.g., first text 602 and/or second text 622) to shape 630 involves aligning the corresponding baseline (e.g., first baseline 608 for first text 602 and second baseline 628 for second text 622) to the edge of shape 630.

As illustrated in FIG. 6K, because second text 622 is snapped to the outside of the bottom right corner of shape 630, as part of displaying second text 622 the computer system displays a portion of second text 622 as upside down. In some embodiments, second text 622 snaps to the inside of the bottom right corner of shape 630 resulting in the computer system displaying a portion of second text 622 as right-side up. As illustrated in FIG. 6K, because first baseline 608 and second baseline 628 are not located at the same position within their respective text boxes and the baselines align with the outer edge of shape 630, the top of first text box 604 does not align with the top of second text box 624. At FIG. 6K, the computer system detects selection input 605k as a select-and-drag input starting in the bottom right corner of shape 630 and moving towards the center of shape 630.

As illustrated in FIG. 6L, in response to detecting selection input 605k, the computer system decreases the size of shape 630. As illustrated in FIG. 6L, as part of decreasing the size of shape 630, the computer system decreases the length of first text box 604 and second text box 624, maintaining the original percentage that each text box covered of the edge of shape 630. For example, if first text 602 covers half the left side and two thirds of the top of shape 630 when shape 630 is large, first text 602 covers half the left side and two thirds of the top of shape 630 when shape 630 is small. In response to decreasing the length of first text box 604 and second text box 624, the computer system displays fewer characters within first text box 604 and second text box 624 and displays first additional content indicator 610 at right end of first text box 604 and second content indicator 636 at the right end of second text box 624. In other embodiments, as part of decreasing the size of shape 630, the computer system does not decrease the length of first text box 604 and second text box 624 until the two text boxes run into each other. Instead, the computer system maintains a location of the left side of each text box with respect to shape 630 while causing the right side of each text box to cover more of shape 630.

FIGS. 6M-6N illustrate the computer system displaying third text box 640 with third text 642 including the characters “ABCDE” with strikethrough 644 and underline 646. In FIGS. 6M-6N, third text box 640 is illustrated with opposite curvatures to demonstrate how the curve of third text box 640 affects how the computer system displays strikethroughs and underlines. As illustrated in FIGS. 6M-6N, the characters “C” and “D” are displayed on either side of the sharpest part of the curvature of third text box 640.

As illustrated in FIG. 6M, the computer system displays third text box 640 with an upward pointing curvature. In response to third text box 640 having the upward pointing curvature, the computer system displays strikethrough 644 as curving smoothly between the characters of “C” and “D” of third text 642. In response to third text box 640 having the upward pointing curvature, the computer system displays underline 646 as coming to a point between the characters of “C” and “D” of third text 642.

As illustrated in FIG. 6N, the computer system displays third text box 640 with a downward pointing curvature. In response to third text box 640 having the downward pointing curvature, the computer system displays strikethrough 644 as coming to a point between the characters of “C” and “D” third text 642 which is different to how the computer system displays strikethrough 644 in FIG. 6M when third text box 640 has the upward pointing curvature. In response to third text box 640 having the downward pointing curvature, the computer system displays underline 646 as coming curving smoothly between the characters of “C” and “D” of third text 642 which is different to how the computer system displays underline 646 in FIG. 6M when third text box 640 has the upward pointing curvature.

In some embodiments, the computer system selectively adjusts the space between characters based on the shape of the text box to prevent collision between characters. As illustrated in FIG. 6N, the computer system displays the characters with a more space between “C” and “D” than between the other characters to prevent collision between the character “C” and character “D” where the curve of third text box 640 is the sharpest. In some embodiments, in response to detecting a selection input on a control to turn off the collision control feature, the computer system does not adjust the space between characters to prevent collision between the characters. In such embodiments, characters can collide easier or sooner than when the collision control feature is turned on.

FIG. 7 is a flow diagram illustrating a process (e.g., process 700) for displaying a text path in accordance with some embodiments. Some operations in process 700 are, optionally, combined, the orders of some operations are, optionally, changed, and some operations are, optionally, omitted.

As described below, process 700 provides an intuitive way for displaying a text path. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system that is in communication with (and/or includes) one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, a head mounted display, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

While displaying, via the one or more display generation components, (1) a text box (e.g., a user interface element configured to include text, a user interface element configured to allow a user to input text within a defined area, and/or a defined area within a user interface) (e.g., 604 as described with respect to FIG. 6A) with a first set of one or more vertices (e.g., point on a curve where direction changes and/or corner point of two line segments) and (2) a control point (e.g., 604a and/or 604b) (e.g., pivot point, anchor point, node, handle, and/or selectable portion of the text box), the computer system detects (702), via the one or more input devices, an input (e.g., 605a, 605b, 605c, and/or 605d) (e.g., selection input and/or non-selection input) corresponding to the control point. In some embodiments, while detecting the input corresponding to the control point, the computer system does not display one or more indications of the first set of one or more vertices. In some embodiments, the control point is part of the text box. In some embodiments, the control point is separate from the text box. In some embodiments, the control point is only displayed while the text box is selected. In some embodiments, the control point is not displayed while the text box is not selected. In some embodiments, the input corresponds to the control point when the input is initiated at a location corresponding to the control point. In some embodiments, the input is a select-and-hold input that is initiated at a location corresponding to the control point.

In response to detecting the input corresponding to the control point (e.g., as described with respect to FIG. 6A) and in accordance with a determination that a first set of one or more criteria is satisfied, wherein the first set of one or more criteria includes a criterion that is satisfied when the input corresponding to the control point includes a first path (e.g., a first direction and/or a first distance), the computer system displays (704) (e.g., as described with respect to FIG. 6B), via the one or more display generation components, the text box with a second set of one or more vertices (e.g., as described with respect to FIG. 6B) different from the first set of one or more vertices (e.g., without displaying the text box with the first set of one or more vertices), wherein the second set of one or more vertices includes a different number of vertices than the first set of one or more vertices. In some embodiments, the text box with the second set of one or more vertices includes a shape of the first path. In some embodiments, the text box with the second set of one or more vertices includes a portion that follows the first path.

In some embodiments, the text box with the second set of one or more vertices (e.g., 604 as described with respect to FIG. 6B) includes a portion that is in a shape corresponding to (e.g., related to and/or associated with) the first path. In some embodiments, in response to detecting the input corresponding to the control point and in accordance with a determination that a second set of one or more criteria, different from the first set of one or more criteria, is satisfied, wherein the second set of one or more criteria includes a criterion that is satisfied when the input corresponding to the control point includes a second path (e.g., 605b as described with respect to FIG. 6B) (e.g., a second direction and/or a second distance) different from the first path, the computer system displays, via the one or more display generation components, the text box with a third set of one or more vertices (e.g., as described with respect to FIG. 6C), wherein the text box with the third set of one or more vertices includes a portion that is in a shape corresponding to the second path (e.g., and not the first path). In some embodiments, the text box with the third set of one or more vertices includes a shape of the second path. In some embodiments, the text box with the third set of one or more vertices includes a portion that follows the second path. In some embodiments, the third set of one or more vertices is different from the first set of one or more vertices and/or the second set of one or more vertices. In some embodiments, the third set of one or more vertices includes a different number of vertices than the first set of one or more vertices and/or the second set of one or more vertices. In some embodiments, the third set of one or more vertices is the same number of vertices as the first set of one or more vertices or the second set of one or more vertices. Changing a number of vertices of a text box in response to detecting an input with different paths allows the computer system to have dynamically shaped text boxes based on inputs, thereby reducing the number of inputs needed to perform an operation, providing additional control options without cluttering the user interface with additional displayed controls, and/or performing an operation when a set of conditions has been met without requiring further user input.

In some embodiments, the second set of one or more vertices has more vertices than the first set of one or more vertices (e.g., as described with respect to FIGS. 6A-6B). In some embodiments, the second set of one or more vertices has less vertices than the first set of one or more vertices. (e.g., as described with respect to FIGS. 6A-6B)

In some embodiments, display of the text box with the first set of one or more vertices includes display of a first set of one or more characters (e.g., a text, a letter, a glyph, and/or a number) in a first appearance (e.g., an orientation, a size, an alignment, and/or a direction). In some embodiments, display of the text box with the second set of one or more vertices maintains display of the first set of one or more characters in the first appearance (e.g., as described with respect to FIGS. 6A-6B) (e.g., changing a number of vertices of the text box does not change an appearance of characters in the text box). In some embodiments, the set of one or more characters are positioned within the text box. In some embodiments, the first set of one or more characters are displayed with a first appearance (e.g., an orientation, a size, an alignment, and/or a direction) while the text box has the first set of one or more vertices. In some embodiments, the first set of one or more characters are displayed with a second appearance (e.g., an orientation, a size, an alignment, and/or a direction) (e.g., and not the first appearance), different from the first appearance, while the text box has the second set of one or more vertices. Changing vertices of a text box without changing text within the text box allows the computer system to add additional length to the text box based on a path of an input without modifying an appearance of the text, thereby reducing the number of inputs needed to perform an operation, providing additional control options without cluttering the user interface with additional displayed controls, and/or performing an operation when a set of conditions has been met without requiring further user input.

In some embodiments, display of the text box with the first set of one or more vertices includes display of a first set of one or more characters (e.g., a text, a letter, a glyph, and/or a number) with a first appearance (e.g., an orientation, a size, an alignment, and/or a direction). In some embodiments, display of the text box with the second set of one or more vertices includes display of the first set of one or more characters with a second appearance (e.g., as described with respect to FIGS. 6A-6B) (e.g., a set of characters, an orientation, a size, an alignment, and/or a direction) different from the first appearance. Changing vertices of a text box while changing an appearance of text within the text box allows the computer system to modify the text box and the appearance of text within the text box based on a path of an input, thereby reducing the number of inputs needed to perform an operation, providing additional control options without cluttering the user interface with additional displayed controls, and/or performing an operation when a set of conditions has been met without requiring further user input.

In some embodiments, the text box with the first set of one or more vertices includes a first baseline (e.g., 608) (e.g., positioned within the text box). In some embodiments, the text box with the first set of one or more vertices has a first amount of area above the first baseline along a path of the text box with the first set of one or more vertices and a second amount of area below the first baseline along the path of the text box with the first set of one or more vertices. In some embodiments, the text box with the second set of one or more vertices includes a second baseline (e.g., positioned within the text box). In some embodiments, the text box with the second set of one or more vertices has the first amount of area above the second baseline along a path of the text box with the second set of one or more vertices and the second amount of area below the second baseline along the path of the text box with the second set of one or more vertices (e.g., as described above with respect to FIG. 6H). In some embodiments, while displaying the text box with the first set of one or more vertices, the computer system displays, via the one or more display generation components, the first baseline. In some embodiments, while displaying the text box with the second set of one or more vertices, the computer system displays, via the one or more display generation components, the second baseline. In some embodiments, while displaying the text box with the first set of one or more vertices, the computer system forgoes display of, via the one or more display generation components, the first baseline. In some embodiments, while displaying the text box with the second set of one or more vertices, the computer system forgoes display of, via the one or more display generation components, the second baseline. In some embodiments, the first baseline aligns text within the text box. In some embodiments, the second baseline aligns text within the text box. In some embodiments, the second baseline is different from the first baseline. In some embodiments, the first amount is more than the second amount. In some embodiments, the first amount is less than the second amount. In some embodiments, the first area is the same as the second amount. Maintaining an area above and below a baseline of a text box while changing a number of vertices of the text box allows the computer system to maintain consistently looking text within the text box while dynamically modifying a shape of the text box, thereby reducing the number of inputs needed to perform an operation, providing additional control options without cluttering the user interface with additional displayed controls, and/or performing an operation when a set of conditions has been met without requiring further user input.

In some embodiments, the text box with the first set of one or more vertices includes a first baseline (e.g., 608) (e.g., positioned within the text box). In some embodiments, before detecting the input corresponding to the control point, the computer system displays, via the one or more display generation components, the text box with the first set of one or more vertices without displaying the first baseline (e.g., 624 as described with respect to FIG. 6I) (e.g., within the text box). In some embodiments, while detecting the input corresponding to the control, the computer system displays, via the one or more display generation components, the text box and (and/or with) the first baseline (e.g., as described with respect to FIG. 6A). In some embodiments, the computer system displays the first baseline only when the computer system detects the input corresponding to the control point. In some embodiments, in response to detecting the input corresponding to the control point (e.g., in response to detecting an end of the input corresponding to the control point), the computer system ceases display of the first baseline. Displaying a baseline of a text box while detecting an input to change a number of vertices of the text box while not displaying the baseline after detecting the input to change the number of vertices of the text box allows the computer system to selectively display the baseline such that the baseline is displayed while the baseline is changing orientation, thereby reducing the number of inputs needed to perform an operation, performing an operation when a set of conditions has been met without requiring further user input, and/or providing improved visual feedback to the user.

In some embodiments, the text box with the second set of one or more vertices is at a first position. In some embodiments, the text box with the second set of one or more vertices includes a second baseline (e.g., positioned within the text box). In some embodiments, while displaying the text box with the second set of one or more vertices without displaying the second baseline (e.g., as described with respect to FIG. 6B), the computer system detects, via the one or more input devices, an input (e.g., a selection input and/or a non-selection input) corresponding to a request to move the text box to a second position different from the first position. In some embodiments, the input is a select-and-drag input that is initiated at the text box. In some embodiments, while detecting the input corresponding to the request to move the text box to the second position, the computer system displays, via the one or more display generation components, the text box and (and/or with) the second baseline (e.g., while the text box is moving from the first position to the second position). In some embodiments, the computer system displays the second baseline only when the computer system detects the input corresponding to the request to move the text box to the second position. In some embodiments, in response to detecting the input corresponding to the request to move the text box to the second position (e.g., in response to detecting an end of the input corresponding to the request to move the text box to the second position), the computer system ceases display of the second baseline. Displaying a baseline of a text box while moving the text box and not displaying the baseline while not moving the text box allows the computer system to selectively display the baseline such that the baseline is displayed while the baseline is changing position, thereby reducing the number of inputs needed to perform an operation, performing an operation when a set of conditions has been met without requiring further user input, and/or providing improved visual feedback to the user.

In some embodiments, the text box with the first set of one or more vertices includes a first set of one or more characters (e.g., as described with respect to FIG. 6A) (e.g., a text, a letter, a glyph, and/or a number). In some embodiments, while displaying the text box with the first set of one or more vertices, in accordance with a determination that a third set of one or more criteria is satisfied (e.g., that a baseline is to be displayed), wherein the third set of one or more criteria includes a criterion that is satisfied when a font of the first set of one or more characters includes a first characteristic (e.g., a character height, a character size, and/or an emphasis that affects character height or character size), the computer system displays, via the one or more display generation components, a baseline at a first level (e.g., a height, a position, and/or angle) within the text box. In some embodiments, while displaying the text box with the first set of one or more vertices, in accordance with a determination that a fourth set of one or more criteria, different from the third set of one or more criteria, is satisfied (e.g., that the baseline is to be displayed), wherein the fourth set of one or more criteria includes a second criterion that is satisfied when the font of the first set of one or more characters includes a second characteristic (e.g., a font selection, a size, and/or an effect) different from the first characteristic, the computer system displays, via the one or more display generation components, the baseline at a second level, different from the first level, within the text box. Displaying a baseline of a text box at different levels depending on a characteristic of a font being used allows the computer system to reflect how text is being oriented and how future text will be orientated using the text box, thereby reducing the number of inputs needed to perform an operation, performing an operation when a set of conditions has been met without requiring further user input, and/or providing improved visual feedback to the user.

In some embodiments, display of the text box with the first set of one or more vertices includes display of a first set of one or more characters (e.g., a text, a letter, a glyph, and/or a number) within the textbox with the first set of one or more vertices (e.g., as described with respect to FIG. 6A). In some embodiments, display of the text box with the second set of one or more vertices includes display of the first set of one or more characters (e.g., a text, a letter, a glyph, and/or a number) within the textbox with the second set of one or more vertices. Displaying text within a text box while being able to change a number of vertices of the text box allows the computer system to shape an orientation of the text by detecting inputs with different paths, thereby reducing the number of inputs needed to perform an operation, performing an operation when a set of conditions has been met without requiring further user input, and/or providing improved visual feedback to the user.

In some embodiments, display of the text box with the first set of one or more vertices includes display of a first character and a second character separate from the first character. In some embodiments, the second character is the same character as the first character. In some embodiments, an orientation of the second character is different from an orientation of the first character (e.g., as described with respect to FIG. 6D). Displaying the same character with different orientations at different locations within a text box allows the characters to follow a path of the text both, thereby reducing the number of inputs needed to perform an operation, performing an operation when a set of conditions has been met without requiring further user input, and/or providing improved visual feedback to the user.

In some embodiments, display of the text box with the first set of one or more vertices includes display of a third character and a fourth character separate from the fourth character. In some embodiments, the fourth character is the same character as the third character. In some embodiments, an orientation of the fourth character is the same orientation as an orientation of the third character (e.g., as described with respect to FIG. 6A). Displaying the same character with the same orientation at different locations within a text box allows the characters to follow a path of the text both, thereby reducing the number of inputs needed to perform an operation, performing an operation when a set of conditions has been met without requiring further user input, and/or providing improved visual feedback to the user.

In some embodiments, while (and/or in response to) detecting the input corresponding to the control point and in accordance with a determination that a fifth set of one or more criteria is satisfied, wherein the fifth set of one or more criteria includes a criterion that is satisfied when the input corresponding to the control point includes a third path (e.g., a first direction and/or a first distance) different from the first path (and/or the second path), the computer system ceases display of, via the one or more display generation components, a first portion of the first set of one or more characters (e.g., as described with respect to FIG. 6C) (e.g., while maintaining display of a second portion, different from the first portion, of the first set of one or more characters). Ceasing display of a first portion of a set of one or more characters in a text box in response to detecting an input corresponding to a control point of the text box allows the computer system to limit text in the text box to an amount of the text that fits in the text box, thereby performing an operation when a set of conditions has been met without requiring further user input and/or providing improved visual feedback to the user.

In some embodiments, the control point is a first control point. In some embodiments, the first set of one or more characters is displayed in a first orientation. In some embodiments, while displaying, via the one or more display generation components, (1) the text box with the first set of one or more vertices (e.g., 604 as described with respect to FIG. 6A), (2) the first control point (e.g., a leading edge of the text box), and (3) a second control point (e.g., pivot point, anchor point, node, handle, and/or selectable portion of the text box) (e.g., a trailing edge of the text box) different from the first control point, the computer system detects, via the one or more input devices, an input (e.g., a selection input and/or a non-selection input) corresponding to a respective control point. In some embodiments, the input corresponding to the respective control point is a tap input at either the first control point or the second control point. In some embodiments, the leading edge is an edge of the text box after the text within the text box. In some embodiments, the trailing edge is an edge of the text box where the text begins. In some embodiments, in response to detecting the input corresponding to the respective control point, in accordance with a determination that a sixth set of one or more criteria is satisfied, wherein the sixth set of one or more criteria includes a criterion that is satisfied when the respective control point is the first control point and that the input corresponding to the respective control point includes a fourth path moving toward a center of the text box with the first set of one or more vertices, the computer system ceases display of, via the one or more display generation components, a first portion of the first set of one or more characters (e.g., as described with respect to FIG. 6C) (e.g., while maintaining display of a second portion, different from the first portion, of the first set of one or more characters). In some embodiments, in response to detecting the input corresponding to the respective control point, the second portion of the first set of one or more characters is displayed in the second orientation. In some embodiments, in response to detecting the input corresponding to the respective control point, the second portion of the first set of one or more characters is displayed in a third orientation different from the second orientation. In some embodiments, in response to detecting the input corresponding to the respective control point, in accordance with a determination that a seventh set of one or more criteria, different from the sixth set of one or more criteria, is satisfied, wherein the seventh set of one or more criteria includes a criterion that is satisfied when the respective control point is the second control point and that the input corresponding to the respective control point includes a fifth path different from a fifth path moving toward the center of the text box with the first set of one or more vertices, the computer system displays, via the one or more display generation components, the first set of one or more characters with a second orientation (e.g., as described with respect to FIG. 6C) (e.g., without ceasing display of a portion of the first set of one or more characters) different from the first orientation. Either changing an orientation or ceasing display of a portion of text within a text box in response to detecting an input depending on which control point that the input is directed allows the computer system to enable more control of the text box, thereby performing an operation when a set of conditions has been met without requiring further user input and/or providing improved visual feedback to the user.

In some embodiments, ceasing display of the first portion of the first set of one or more characters includes: in accordance with a determination that the first set of one or more characters includes less than a predefined number of characters, ceasing display of, via the one or more display generation components, a single character (e.g., as described with respect to FIGS. 6A-6B) (e.g., and not a word); and in accordance with a determination that the first set of one or more characters includes more than the predefined number of characters, ceasing display of, via the one or more display generation components, a word (e.g., as described with respect to FIGS. 6A-6B) (e.g., a plurality of characters). Ceasing display of text in different manners depending on a number of characters of the text allows the computer system to enable more control of removing when less characters are present, thereby performing an operation when a set of conditions has been met without requiring further user input and/or providing improved visual feedback to the user.

In some embodiments, in response to detecting the input corresponding to the respective control point and in accordance with a determination that the sixth set of one or more criteria is satisfied (e.g., after (and/or in response to) ceasing display of the first portion of the first set of one or more characters), the computer system displays, via the one or more display generation components, a user interface element (e.g., 610 as described with respect to FIG. 6C) (e.g., graphic, image, and/or icon) at a leading edge of the text box. In some embodiments, while displaying the user interface element at the leading edge of the text box, detecting, via the one or more input devices, an input (e.g., a selection input and/or a non-selection input) corresponding to the user interface element at the leading edge of the text box. In some embodiments, in response to detecting the input corresponding to the user interface element at the leading edge of the text box, displaying, via the one or more display generation components, the first portion of the first set of one or more characters. In some embodiments, the input corresponding to the user interface element at the leading edge of the text box is a tap input at the user interface element at the leading edge of the text box. In some embodiments, the user interface element at the leading edge of the text box is not displayed before ceasing display of the first portion of the first set of one or more characters. Displaying a user interface element at a leading edge of a text box when ceasing display of a portion of content in the text box allows the computer system to indicate when and/or where text of the text box is not currently displayed, thereby performing an operation when a set of conditions has been met without requiring further user input and/or providing improved visual feedback to the user.

In some embodiments, display of the text box with the first set of one or more vertices includes display of a plurality of characters (e.g., a text, a letter, a glyph, and/or a number) within the textbox with the first set of one or more vertices (e.g., as described with respect to FIG. 6A). In some embodiments, the first plurality of characters includes a first spacing (e.g., a length and/or a distance) between a first character of the plurality of characters and a second character of the plurality of characters. In some embodiments, the second character is separate from the first character. In some embodiments, in response to detecting the input corresponding to the control point, in accordance with a determination that an eighth set of one or more criteria is satisfied, wherein the eighth set of one or more criteria includes a criterion that is satisfied when the input corresponding to the control point includes a sixth path (e.g., a sixth direction and/or a sixth distance), the computer system displays, via the one or more display components, the plurality of characters including the first spacing between the first character and the second character (e.g., as described with respect to FIG. 6N). In some embodiments, the eighth set of one or more criteria includes a criterion that is satisfied when a setting to prevent collisions is not activated. In some embodiments, in response to detecting the input corresponding to the control point, in accordance with a determination that a ninth set of one or more criteria, different from the eighth criteria, is satisfied, wherein the ninth set of one or more criteria includes a criterion that is satisfied when the input corresponding to the control point includes the sixth path, the computer system displays, via the one or more display components, the plurality of characters including a second spacing, different from the first spacing, between the first character and the second character (e.g., as described with respect to FIG. 6N) (e.g., to prevent a collision between the first character and the second character). In some embodiments, the ninth set of one or more criteria includes a criterion that is satisfied when the setting to prevent collisions is activated. Selectively changing a space between characters when different criteria is satisfied allows the computer system to be configured to avoid collisions between characters or not, thereby performing an operation when a set of conditions has been met without requiring further user input and/or providing improved visual feedback to the user.

In some embodiments, display of the text box with the first set of one or more vertices includes display of the text box with a first length (e.g., 604 as described with respect to FIG. 6A). In some embodiments, in response to detecting the input corresponding to the control point and in accordance with a determination that a tenth set of one or more criteria is satisfied, wherein the tenth set of one or more criteria includes a criterion that is satisfied when the input corresponding to the control point includes a seventh path moving away from the text box with the first set of one or more vertices, the computer system displays, via the one or more display generation components, the text box with a second length longer than the first length without changing an orientation of the text box that was included in the text box before detecting the input corresponding to the control point (e.g., as described with respect to FIGS. 6A-6B). Adding length to a text box without changing an orientation of the text box when an input is detected moving away from the text box allows the computer system to provide more control of shaping text boxes, thereby performing an operation when a set of conditions has been met without requiring further user input and/or providing improved visual feedback to the user.

In some embodiments, while displaying the text box with the second set of one or more vertices, the computer system displays, via the one or more display generation components, content (e.g., an image, a line, a square, a circle, a video, and/or text). In some embodiments, while displaying the text box with the second set of one or more vertices and the content, the computer system detects, via the input device, an input (e.g., a selection input and/or a non-selection input) corresponding to (e.g., directed to, at a location of, related to, and/or associated with) a request to move the text box with the second set of one or more vertices. In some embodiments, while detecting the input corresponding to the request to move the text box with the second set of one or more vertices, in accordance with a determination that an eleventh set of one or more criteria is satisfied, wherein the eleventh set of one or more criteria includes a criterion that is satisfied when the input corresponding to the request to move the text box with the second set of one or more vertices is at a first location corresponding to (e.g., associated with, in proximity to, and/or or related to) the content, the computer system displays, via the one or more display generation components, a first portion (e.g., an edge, a section, a side, and/or a line) of the content with a first visual emphasis (e.g., as described with respect to FIGS. 6I-6K) (e.g., while another portion, different from the first portion, of the content is displayed without visual emphasis). In some embodiments, the first visual emphasis is highlighting the first portion. In some embodiments, the first portion corresponds to the first location. In some embodiments, the first portion is a length of the text box with the second set of one or more vertices. In some embodiments, the first portion is a preview of where the text box will be positioned. In some embodiments, the input corresponding to the request to move the text box with the second set of one or more vertices is drag-hold input from the text box toward the content. In some embodiments, a path of the first portion is a different path than the text box with the second set of one or more vertices. In some embodiments, while detecting the input corresponding to the request to move the text box with the second set of one or more vertices, in accordance with a determination that a twelfth set of one or more criteria, different from the eleventh set of one or more criteria, is satisfied, wherein the twelfth set of one or more criteria includes a criterion that is satisfied when the input corresponding to the request to move the text box with the second set of one or more vertices is at a second location, different from the first location, the computer system corresponds to (e.g., associated with, in proximity to, and/or or related to) the content with the first shape, displaying, via the one or more display generation components, a second portion (e.g., an edge, a section, a side, and/or a line) of the content, different from the first portion of the content, with the first visual emphasis (e.g., as described with respect to FIGS. 6I-6K) (e.g., while another portion, different from the second portion, of the content is displayed without visual emphasis). In some embodiments, the second portion corresponds to the second location. In some embodiments, the second portion is a length of the text box with the second set of one or more vertices. In some embodiments, the second portion is a preview of where the text box will be positioned. In some embodiments, a path of the second portion is a different path than the text box with the second set of one or more vertices. Displaying a portion of content with a first visual emphasis while detecting an input corresponding to a request to move a text box toward the portion of the content allows the computer system to preview where the text box will be located when following an edge of the content, thereby performing an operation when a set of conditions has been met without requiring further user input and/or providing improved visual feedback to the user.

In some embodiments, after (and/or in response to) detecting the input corresponding to the request to move the text box with the second set of one or more vertices and in accordance with a determination that termination of the input corresponding to the request to move the text box with the second set of one or more vertices corresponds to the content, the computer system displays, via the one or more display generation components, the text box wrapped along a path of the content. (e.g., as described with respect to FIGS. 6I-6K. In some embodiments, the text box wrapped along the path of the content includes a different path than the text box with the second set of one or more vertices. In some embodiments, the path of the content is along an exterior boundary of the content. Displaying a text box wrapped along a path of content based on where the text box was moved allows the computer system to automatically configure a path of the text box using other content, thereby performing an operation when a set of conditions has been met without requiring further user input and/or providing improved visual feedback to the user.

In some embodiments, the text box is a first text box. In some embodiments, the path is a first path. In some embodiments, while displaying the first text box wrapped along the first path of the content, the computer system detects, via the one or more input devices, an input (e.g., a selection input and/or a non-selection input) corresponding to (e.g., directed to, at a location of, related to, and/or associated with) a request to move a second text box different from the first text box. In some embodiments, in response to detecting the input corresponding to the request to move the second text box and in accordance with a determination that termination of the input corresponding to the request to move the second text box corresponds to the content, the computer system displays, via the one or more display generation components, the second text box wrapped along a second path, different from the first path, of the content while displaying the first text box wrapped along the first path of the content (e.g., as described with respect to FIGS. 6I-6K). Wrapping multiple text boxes along content allows the computer system more control of placement of texts boxes, thereby performing an operation when a set of conditions has been met without requiring further user input and/or providing improved visual feedback to the user.

In some embodiments, while displaying the text box with the second set of one or more vertices, the computer system detects, via the one or more input devices, an input (e.g., a selection input and/or a non-selection input) corresponding to (e.g., directed to, at a location of, related to, and/or associated with) a request to edit the text box with the second set of one or more vertices. In some embodiments, the input corresponding to the request to edit the text box with the second set of one or more vertices is a tap input on an edit control. In some embodiments, in response to detecting the input corresponding to the request to edit the text box with the second set of one or more vertices, the computer system displays, via the one or more display generation components, a first indication of a first vertex of the second set of one or more vertices and a second indication of a second vertex of the second set of one or more vertices with the text box with the second set of one or more vertices, wherein the second vertex is separate from the first vertex (e.g., as described with respect to FIGS. 6I-6K). In some embodiments, in response to detecting the input corresponding to the request to edit the text box with the second set of one or more vertices, the computer system displays, via the one or more display generation components, an indication of each vertex of the second set of one or more vertices. Displaying indications of different vertices of the second set of one or more vertices allows the computer system to indicate a configuration of the second set of one or more vertices enabling display of the text box with the second set of one or more vertices, thereby performing an operation when a set of conditions has been met without requiring further user input and/or providing improved visual feedback to the user.

Note that details of the processes described above with respect to process 700 (e.g., FIG. 7) are also applicable in an analogous manner to other processes described herein. For example, process 900 optionally includes one or more of the characteristics of the various processes described above with reference to process 700. For example, the output of process 900 can be displayed by process 700. For brevity, these details are not repeated herein.

FIGS. 8A-8C illustrate exemplary processes for controlling text placement in accordance with some embodiments. The user interfaces in these figures are used to illustrate the processes described below, including the processes in FIG. 9.

FIGS. 8A-8C illustrate text and user interface elements displayed by a computer system, such as a laptop with a keyboard and a touch sensitive display screen. It should be recognized that the text and user interface elements can be displayed by other types of computer systems, such as a smart phone, a tablet, a personal gaming system, a desktop computer, and/or a head-mounted display (HMD) device. In some embodiments, computer system 600 includes and/or is in communication with one or more input devices and/or sensors (e.g., a camera, a LiDAR sensor, a motion sensor, an infrared sensor, a microphone, a touch-sensitive surface, and/or a physical input mechanism such as a keyboard, a mouse, button, a rotational mechanism, and/or a slider). Such sensors can be used to detect presence of, attention of, statements from, inputs corresponding to, requests from, and/or instructions from a user in an environment. It should be recognized that, while some embodiments described herein refer to inputs being touch inputs detected via a touch-sensitive surface, other types of inputs can be used with techniques described herein, such as voice inputs that are detected via one or more microphones and/or air gestures detected via a camera that is in communication (e.g., wireless and/or wired communication) with the computer system.

FIGS. 8A-8B illustrate the computer system displaying shape 802, first character 804, second character 806, and third character 808. At FIGS. 8A-8B, first character 804, second character 806, and third character 808 are configured to align with a path determined by the edges of shape 802. The orientations of first character 804, second character 806, and third character 808 are calculated differently in FIG. 8A than the orientations of the characters in FIG. 8B.

At FIG. 8A, the computer system calculates the orientation of first character 804 using an orientation of an edge of shape 802 at a point below first character 804, as indicated by first point calculation indicator 810. As illustrated in FIG. 8A, in response to calculating the orientation of first character 804 using the orientation of the edge of shape 802 at a point below first character 804, the computer system displays first character 804 oriented so that the base of first character 804 is aligned with the edge of shape 802. At FIG. 8A, the computer system calculates the orientation of second character 806 using an orientation of an edge of shape 802 at a point below second character 806, as indicated by second point calculation indicator 812. As illustrated in FIG. 8A, in response to calculating the orientation of second character 806 using the orientation of the edge of shape 802 at a point below second character 806, the computer system displays second character 806 oriented so that the base of second character 806 is aligned with the edge of shape 802. At FIG. 8A, the computer system calculates the orientation of third character 808 using an orientation of an edge of shape 802 at a point below third character 808, as indicated by third point calculation indicator 814. As illustrated in FIG. 8A, in response to calculating the orientation of third character 808 using the orientation of the edge of shape 802 at a point below third character 808, the computer system displays third character 808 oriented so that the base of third character 808 is aligned with the edge of shape 802.

At FIG. 8B, the computer system calculates the orientation of first character 804 using an average of an orientation of a portion of edges of shape 802 within an area below first character 804 that is wider than first character 804, as indicated by first average calculation indicator 816. As illustrated in FIG. 8B, in response to calculating the orientation of first character 804 using the average of the orientation of the portion of edges of shape 802 within the area below first character 804 that is wider than first character 804, the computer system displays first character 804 as not aligned with any one edge of shape 802, which is different than how the computer system displays first character 804 in FIG. 8A. At FIG. 8B, the computer system calculates an orientation of second character 806 using an average of an orientation of a portion of edges of shape 802 within an area below second character 806 that is wider than second character 806, as indicated by second average calculation indicator 818. As illustrated in FIG. 8B, in response to calculating the orientation of second character 806 using the average of the orientation of the portion of edges of shape 802 within the area below second character 806 that is wider than second character 806, the computer system displays second character 806 perched on the top point of shape 802, which is different than how the computer system displays second character 806 in FIG. 8A. At FIG. 8B, the computer system calculates an orientation of third character 808 using an average of an orientation of a portion of edges of shape 802 within an area below third character 808 that is wider than third character 808, as indicated by third average calculation indicator 820. As illustrated in FIG. 8B, in response to calculating the orientation of third character 808 using the average of the orientation of the portion of edges of shape 802 within the area below first character 804 that is wider than third character 808, the computer system displays third character 808 as not aligned with any one edge of shape 802, which is different than how the computer system displays third character 808 in FIG. 8A.

At FIG. 8C, a path that the characters are configured to align with is determined by a curvature of text box 830. As illustrated in FIG. 8C, the computer system displays first character 804, second character 806, third character 808, fourth character 832, and fifth character 834 within text box 830. At FIG. 8C, the computer system calculates an orientation of first character 804, second character 806, and fifth character 834 using the method discussed above in FIG. 8A, as indicated by first point calculation indicator 810, second point calculation indicator 812, and fifth point calculation indicator 838. At FIG. 8C, the computer system calculates an orientation of third character 808 and fourth character 832 using the method discussed above in FIG. 8B, as indicated by third average calculation indicator 820 and fourth average calculation indicator 836.

In some embodiments, the computer system determines which method to use to calculate (e.g., calculate based on an orientation of a path at a point or based on an average of an orientation of a path in an area) an orientation of each character based on a rate of change in an orientation of a path in an area occupied by that character. At FIG. 8C, the computer system calculates the orientation of first character 804, second character 806, and fifth character 834 using the orientation of the path at a point in response to a determination that the rate of change of the orientation of text box 830 at the areas occupied by those characters is below a predetermined threshold (e.g., the curve is more shallow). At FIG. 8C, the computer system calculates the orientation of third character 808 and fourth character 832 using the average orientation of the path in an area larger than the character in response to a determination that the rate of change of the orientation of text box 830 at the areas occupied by those characters is above a predetermined threshold (e.g., the curve is sharper). In some embodiments, which calculation the computer system uses to calculate the orientation of a character also effects the orientation of character emphasis, such as underlines and strikethroughs.

In some embodiments, an orientation of a character is the same when calculated using a point or an average of an orientation of a path that the character is configured to align with. For example, if a shape that is determining the path is flat, a calculation that uses the orientation of the path at a point and a calculation that uses the average of the orientation of the path will result in the same orientation. For another example, if a shape that is determining a path is a perfect circle, a calculation that uses an orientation of a path at a point and a calculation that uses an average of an orientation of a path will result in the same orientation. In some embodiments, the computer system uses an amount of the path that is between a point and an area wider than the character to calculate the orientation of that character. For example, the computer system uses an average of the orientation of the path in an area below the character and that is half the width of the character.

It should be recognized that an area used for averaging can be more or less than illustrated above. It should also be recognized that an area used for averaging can be different for different characters, such as larger area for characters in the middle of a text box and smaller area for characters near an end of a text box. It should also be recognized that other criteria can be used to determine which method to use to calculate an orientation. For example, a greater amount of overlap between two characters when using one method can cause the computer system to use the other method. For another example, a greater difference in orientation between multiple characters when using one method can cause the computer system to the other method.

FIG. 9 is a flow diagram illustrating a process (e.g., process 900) for outputting a text position in accordance with some embodiments. Some operations in process 900 are, optionally, combined, the orders of some operations are, optionally, changed, and some operations are, optionally, omitted.

As described below, process 900 provides an intuitive way for outputting a text position. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system. In some embodiments, the computer system is a watch, a phone, a tablet, a fitness tracking device, a processor, a head-mounted display (HMD) device, a communal device, a media device, a speaker, a television, an electronic device, and/or a personal computing device.

The computer system receives (902) an input corresponding to (e.g., directed to, related to, and/or associated with) a request for an orientation (e.g., an arrangement, an alignment, and/or a position) of a character (and/or a set of one or more characters) along a path (e.g., of a text box, such as described above with respect to process 700). In some embodiments, the input is received (e.g., via an API, method call, and/or system call) from an application of the computer system and/or another computer system different from the computer system. In some embodiments, the input is received (e.g., via an API, method call, and/or system call) from a process, such as a system process or an application process, of the computer system and/or another computer system different from the computer system. In some embodiments, the input is received from a device external to the computer system. In some embodiments, the input is received, via one or more input device (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) in communication with (and/or included in) the computer system.

In response to (904) receiving the input corresponding to the request for the orientation of the character along the path and in accordance with a determination that a first set of one or more criteria is satisfied (e.g., as described with FIGS. 8A-8C) (e.g., that the path has more than a threshold amount of curvature and/or that the input corresponding to the request for the orientation of the character along the path was received), the computer system identifies (906) (e.g., calculates, generates, and/or selects), based on an average orientation of a first portion (e.g., as described with respect to FIGS. 8B and 8C) (e.g., of the path, such as an area, a length, and/or a segment) along the path (e.g., an average of multiple orientations at different points in the first portion along the path), a first orientation for the character, wherein the first portion along the path is larger than a width (and/or a portion, an area, a length, and/or a segment) of (e.g., occupied by, related to, and/or associated with) the character. In some embodiments, different orientations for the character are identified when the character is along different paths and/or at different portions of a path with different average orientations of a length equal to the first portion. In some embodiments, the first portion along the path includes multiple characters.

In response to (904) receiving the input corresponding to the request for the orientation of the character along the path and in accordance with the determination that the first set of one or more criteria is satisfied, the computer system outputs (908) an indication of the first orientation (e.g., as described with respect to FIG. 8B) (e.g., outputs the character with and/or in the first orientation and/or an identification of the first orientation). In some embodiments, outputting the indication of the first orientation includes displaying, via one or more display generation components in communication with and/or included in the computer system, the character with and/or in the first orientation. In some embodiments, outputting the indication of the first orientation includes sending a representation of the character with and/or in the first orientation to another application, process, and/or device.

In some embodiments, in response to receiving the input corresponding to the request for the orientation of the character along the path and in accordance with a determination that a second set of one or more criteria, different from the first set of one or more criteria, is satisfied (e.g., that the path has less than a threshold amount of curvature and/or that the input corresponding to the request for the orientation of the character along the path was received), the computer system identifies (e.g., calculates, generates, and/or selects), based on an orientation of a second portion (e.g., of the path, such as a point, an area, a length, and/or a segment) along the path (e.g., an average of multiple orientations at different points in the first portion along the path) different from the first portion along the path, a second orientation (e.g., an arrangement, an alignment, and/or a position) for the character, wherein the second portion along the path is smaller (and/or shorter) than the first portion (e.g., as described with respect to FIG. 8B). In some embodiments, the second portion along the path consists of a single character. In some embodiments, the second portion along the path is a point along the path. In some embodiments, in response to receiving the input corresponding to the request for the orientation of the character along the path and in accordance with the determination that the second set of one or more criteria, different from the first set of one or more criteria, is satisfied, the computer system outputs an indication of the second orientation (e.g., as described with respect to FIG. 8B) (e.g., outputs the character with and/or in the second orientation and/or an identification of the second orientation). In some embodiments, outputting the indication of the second orientation includes displaying, via one or more display generation components in communication with and/or included in the computer system, the character with and/or in the second orientation. In some embodiments, outputting the indication of the second orientation includes sending a representation of the character with and/or in the second orientation to another application, process, and/or device.

In some embodiments, the character is a first character. In some embodiments, after outputting the indication of the first orientation, the computer system receives an input corresponding to (e.g., related to and/or associated with) a request for an orientation of a second character, different from the first character, along the path. In some embodiments, in response to receiving the input corresponding to the request for the orientation of the second character along the path and in accordance with a determination that a third set of one or more criteria (e.g., the second set of one or more criteria or another set of one or more criteria different from the second set of one or more criteria), different from the first set of one or more criteria, is satisfied, wherein the third set of one or more criteria includes a criterion that is satisfied when a rate of change of orientation of different points of a third portion (e.g., the third portion including the second character) along the path, different from (and/or separate from) the first portion along the path, is below a threshold, the computer system identifies, based on a point (e.g., as described with respect to FIG. 8A) (e.g., not an average) along the third portion along the path (e.g., the path including the second character), a third orientation for the second character. In some embodiments, in response to receiving the input corresponding to the request for the orientation of the second character along the path and in accordance with the determination that the third set of one or more criteria, different from the first set of one or more criteria, is satisfied, wherein the third set of one or more criteria includes the criterion that is satisfied when the rate of change of orientation of different points of the third portion along the path, different from the first portion along the path, is below the threshold, the computer system outputs an indication of the third orientation (e.g., as described with respect to FIG. 8A) (e.g., outputs the second character with and/or in the third orientation and/or an identification of the third orientation). In some embodiments, outputting the indication of the third orientation includes displaying, via one or more display generation components in communication with and/or included in the computer system, the second character with and/or in the third orientation. In some embodiments, outputting the indication of the third orientation includes sending a representation of the second character with and/or in the third orientation to another application, process, and/or device.

In some embodiments, in response to receiving the input corresponding to the request for the orientation of the second character along the path and in accordance with a determination that a fourth set of one or more criteria (e.g., the first set of one or more criteria or another set of one or more criteria different from the first set of one or more criteria), different from the third set of one or more criteria, is satisfied, wherein the fourth set of one or more criteria includes a criterion that is satisfied when the rate of change of orientation of the different points of the third portion along the path is above the threshold (e.g., as described with respect to FIGS. 8B-8C), the computer system identifies, based on an average orientation of the third portion along the path (e.g., as described with respect to FIGS. 8B-8C), a fourth orientation for the second character. In some embodiments, the third portion along the path includes multiple characters. In some embodiments, in response to receiving the input corresponding to the request for the orientation of the second character along the path and in accordance with the determination that the fourth set of one or more criteria, different from the third set of one or more criteria, is satisfied, wherein the fourth set of one or more criteria includes the criterion that is satisfied when the rate of change of orientation of the different points of the third portion along the path is above the threshold, the computer system outputs an indication of the fourth orientation (e.g., as described with respect to FIGS. 8B-8C) (e.g., outputs the second character with and/or in the fourth orientation and/or an identification of the fourth orientation). In some embodiments, outputting the indication of the fourth orientation includes displaying, via one or more display generation components in communication with and/or included in the computer system, the second character with and/or in the fourth orientation. In some embodiments, outputting the indication of the fourth orientation includes sending a representation of the second character with and/or in the fourth orientation to another application, process, and/or device.

In some embodiments, the first portion along the path includes a first character and a second character different (and/or separate) from the first character. In some embodiments, an orientation of the first character is based on an average orientation of a portion around the first character. In some embodiments, an orientation of the second character is based on an average orientation of a portion around the second character. In some embodiments, the portion around the second character is different from the portion around the first character (e.g., as described with respect to FIGS. 8B-8C).

In some embodiments, the first portion along the path includes a third character. In some embodiments, an orientation of the third character is based on an orientation at a point of the third character along the path (e.g., as described with respect to FIG. 8A).

In some embodiments, in response to receiving the input corresponding to the request for the orientation of the character along the path and in accordance with a determination that the character includes a first type of emphasis (e.g., a strikethrough, and/or an underline), the computer system identifies (e.g., calculates, generates, and/or selects), based on the average orientation of the first portion along the path, a first orientation for the first type of emphasis (e.g., as described with respect to FIG. 8A-8C). In some embodiments, in response to receiving the input corresponding to the request for the orientation of the character along the path and in accordance with the determination that the character includes the first type of emphasis, the computer system outputs an indication of the first orientation for the first type of emphasis (e.g., outputs the character with the first type of emphasis in the first orientation and/or an identification of the first orientation for the first type of emphasis). In some embodiments, outputting the indication of the first orientation for the first type of emphasis includes displaying, via one or more display generation components in communication with and/or included in the computer system, the character with the first type of emphasis in the first orientation. In some embodiments, outputting the indication of the first orientation for the first type of emphasis includes sending a representation of the character with the first type of emphasis in the first orientation to another application, process, and/or device.

In some embodiments, in response to receiving the input corresponding to the request for the orientation of the character along the path and in accordance with a determination that the character includes a second type of emphasis (e.g., a strikethrough, and/or an underline) (e.g., different from the first type of emphasis), the computer system identifies (e.g., calculates, generates, and/or selects), based on the orientation of the second portion along the path, a second orientation for the second type of emphasis (e.g., as described with respect to FIG. 8A-8C). In some embodiments, in response to receiving the input corresponding to the request for the orientation of the character along the path and in accordance with the determination that the character includes the second type of emphasis, the computer system outputs an indication of the second orientation for the second type of emphasis (e.g., outputs the character with the second type of emphasis in the second orientation and/or an identification of the second orientation for the second type of emphasis). In some embodiments, outputting the indication of the second orientation for the second type of emphasis includes displaying, via one or more display generation components in communication with and/or included in the computer system, the character with the second type of emphasis in the second orientation. In some embodiments, outputting the indication of the second orientation for the second type of emphasis includes sending a representation of the character with the second type of emphasis in the second orientation to another application, process, and/or device.

In some embodiments, in response to receiving the input corresponding to the request for the orientation of the character along the path, in accordance with a determination that the character includes a first type of emphasis (e.g., a strikethrough, and/or an underline) and that an angle of a portion of the path corresponding to the character is a first angle (e.g., an acute angle, an obtuse angle, a concave angle, or a convex angle), the computer system identifies (e.g., calculates, generates, and/or selects), based on the average orientation of the first portion along the path, a first orientation for the first type of emphasis (e.g., as described with respect to FIG. 8A-8C). In some embodiments, in response to receiving the input corresponding to the request for the orientation of the character along the path, in accordance with the determination that the character includes the first type of emphasis and that an angle of the portion of the path corresponding to the character is the first angle, the computer system outputs an indication of the first orientation for the first type of emphasis (e.g., as described with respect to FIG. 8A-8C) (e.g., outputs the character with the first type of emphasis in the first orientation and/or an identification of the first orientation for the first type of emphasis). In some embodiments, outputting the indication of the first orientation for the first type of emphasis includes displaying, via one or more display generation components in communication with and/or included in the computer system, the character with the first type of emphasis in the first orientation. In some embodiments, outputting the indication of the first orientation for the first type of emphasis includes sending a representation of the character with the first type of emphasis in the first orientation to another application, process, and/or device. In some embodiments, in response to receiving the input corresponding to the request for the orientation of the character along the path, in accordance with a determination that the character includes a second type of emphasis (e.g., a strikethrough, and/or an underline), different from the first type of emphasis, and that the angle of the portion of the path corresponding to the character is the first angle (e.g., an acute angle), the computer system identifies (e.g., calculates, generates, and/or selects), based on the orientation of the second portion along the path, a second orientation for the second type of emphasis. In some embodiments, in response to receiving the input corresponding to the request for the orientation of the character along the path, in accordance with the determination that the character includes the second type of emphasis, different from the first type of emphasis, and that the angle of the portion of the path corresponding to the character is the first angle, the computer system outputs an indication of the second orientation for the second type of emphasis (e.g., as described with respect to FIG. 8A-8C) (e.g., outputs the character with the second type of emphasis in the second orientation and/or an identification of the second orientation for the second type of emphasis). In some embodiments, outputting the indication of the second orientation for the second type of emphasis includes displaying, via one or more display generation components in communication with and/or included in the computer system, the character with the second type of emphasis in the second orientation. In some embodiments, outputting the indication of the second orientation for the second type of emphasis includes sending a representation of the character with the second type of emphasis in the second orientation to another application, process, and/or device. In some embodiments, in response to receiving the input corresponding to the request for the orientation of the character along the path, in accordance with a determination that the character includes the first type of emphasis and that the angle of the portion of the path corresponding to the character is a second angle (e.g., an acute angle, an obtuse angle, a concave angle, or a convex angle) different from the first angle, the computer system identifies (e.g., calculates, generates, and/or selects), based on the orientation of the second portion along the path, a third orientation for the first type of emphasis. In some embodiments, in response to receiving the input corresponding to the request for the orientation of the character along the path, in accordance with the determination that the character includes the first type of emphasis and that the angle of the portion of the path corresponding to the character is the second angle different from the first angle, the computer system outputs an indication of the third orientation for the first type of emphasis (e.g., as described with respect to FIG. 8A-8C) (e.g., outputs the character with the first type of emphasis in the third orientation and/or an identification of the third orientation for the first type of emphasis). In some embodiments, outputting the indication of the third orientation for the first type of emphasis includes displaying, via one or more display generation components in communication with and/or included in the computer system, the character with the first type of emphasis in the third orientation. In some embodiments, outputting the indication of the third orientation for the first type of emphasis includes sending a representation of the character with the first type of emphasis in the third orientation to another application, process, and/or device. In some embodiments, in response to receiving the input corresponding to the request for the orientation of the character along the path, in accordance with a determination that the character includes the second type of emphasis and that the angle of the portion of the path corresponding to the character is the second angle, the computer system identifies (e.g., calculates, generates, and/or selects), based on the average orientation of the first portion along the path, a fourth orientation for the second type of emphasis. In some embodiments, in response to receiving the input corresponding to the request for the orientation of the character along the path, in accordance with the determination that the character includes the second type of emphasis and that the angle of the portion of the path corresponding to the character is the second angle, the computer system outputs an indication of the fourth orientation for the second type of emphasis (e.g., as described with respect to FIG. 8A-8C) (e.g., outputs the character with the second type of emphasis in the fourth orientation and/or an identification of the fourth orientation for the second type of emphasis). In some embodiments, outputting the indication of the fourth orientation for the second type of emphasis includes displaying, via one or more display generation components in communication with and/or included in the computer system, the character with the second type of emphasis in the fourth orientation. In some embodiments, outputting the indication of the fourth orientation for the second type of emphasis includes sending a representation of the character with the second type of emphasis in the fourth orientation to another application, process, and/or device. In some embodiments, in response to receiving the input corresponding to the request for the orientation of the character along the path and in accordance with a determination that the character includes a first type of emphasis (e.g., a strikethrough, and/or an underline) and that an angle of a portion of the path corresponding to the character is a first angle (e.g., an acute angle, an obtuse angle, a concave angle, or a convex angle), the computer system outputs an indication of the first type of emphasis such that the first type of emphasis is smooth (and/or rounded). In some embodiments, in response to receiving the input corresponding to the request for the orientation of the character along the path and in accordance with a determination that the character includes the first type of emphasis and that the angle of the portion of the path corresponding to the character is a second angle (e.g., an acute angle, an obtuse angle, a concave angle, or a convex angle) different from the first angle, the computer system outputs an indication of the first type of emphasis such that the first type of emphasis is not smooth (and/or not rounded and/or comes to a point). In some embodiments, in response to receiving the input corresponding to the request for the orientation of the character along the path and in accordance with a determination that the character includes a second type of emphasis (e.g., a strikethrough, and/or an underline) and that the angle of the portion of the path corresponding to the character is the first angle (e.g., an acute angle, an obtuse angle, a concave angle, or a convex angle), the computer system outputs an indication of the second type of emphasis such that the second type of emphasis is not smooth (and/or not rounded and/or comes to a point). In some embodiments, in response to receiving the input corresponding to the request for the orientation of the character along the path and in accordance with a determination that the character includes the second type of emphasis and that the angle of the portion of the path corresponding to the character is the second angle, the computer system outputs an indication of the second type of emphasis such that the first type of emphasis is smooth (and/or rounded).

Note that details of the processes described above with respect to process 900 (e.g., FIG. 9) are also applicable in an analogous manner to the processes described herein. For example, process 700 optionally includes one or more of the characteristics of the various processes described herein with reference to process 900. For example, the text path of process 700 can be calculated by process 900. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve displaying text. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for displaying text. Accordingly, use of such personal information data enables users to have a computer system perform operations for displaying text. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with one or more input devices and one or more display generation components:
while displaying, via the one or more display generation components, (1) a text box with a first set of one or more vertices and (2) a control point, detecting, via the one or more input devices, an input corresponding to the control point;
in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

2. The method of claim 1, wherein the text box with the second set of one or more vertices includes a portion that is in a shape corresponding to the first path, the method further comprising:
in response to detecting the input corresponding to the control point and in accordance with a determination that a second set of one or more criteria, different from the first set of one or more criteria, is satisfied, wherein the second set of one or more criteria includes a criterion that is satisfied when the input corresponding to the control point includes a second path different from the first path, displaying, via the one or more display generation components, the text box with a third set of one or more vertices, wherein the text box with the third set of one or more vertices includes a portion that is in a shape corresponding to the second path.

3. The method of claim 1, wherein the second set of one or more vertices has more vertices than the first set of one or more vertices.

4. The method of claim 1, wherein the second set of one or more vertices has less vertices than the first set of one or more vertices.

5. The method of claim 1, wherein display of the text box with the first set of one or more vertices includes display of a first set of one or more characters in a first appearance, and wherein display of the text box with the second set of one or more vertices maintains display of the first set of one or more characters in the first appearance.

6. The method of claim 1, wherein display of the text box with the first set of one or more vertices includes display of a first set of one or more characters with a first appearance, and wherein display of the text box with the second set of one or more vertices includes display of the first set of one or more characters with a second appearance different from the first appearance.

7. The method of claim 1, wherein the text box with the first set of one or more vertices includes a first baseline, wherein the text box with the first set of one or more vertices has a first amount of area above the first baseline along a path of the text box with the first set of one or more vertices and a second amount of area below the first baseline along the path of the text box with the first set of one or more vertices, wherein the text box with the second set of one or more vertices includes a second baseline, and wherein the text box with the second set of one or more vertices has the first amount of area above the second baseline along a path of the text box with the second set of one or more vertices and the second amount of area below the second baseline along the path of the text box with the second set of one or more vertices.

8. The method of claim 1, wherein the text box with the first set of one or more vertices includes a first baseline, the method further comprising:
before detecting the input corresponding to the control point, displaying, via the one or more display generation components, the text box with the first set of one or more vertices without displaying the first baseline; and
while detecting the input corresponding to the control, displaying, via the one or more display generation components, the text box and the first baseline; and
in response to detecting the input corresponding to the control point, ceasing display of the first baseline.

9. The method of claim 1, wherein the text box with the second set of one or more vertices is at a first position, wherein the text box with the second set of one or more vertices includes a second baseline, the method further comprising:
while displaying the text box with the second set of one or more vertices without displaying the second baseline, detecting, via the one or more input devices, an input corresponding to a request to move the text box to a second position different from the first position;
while detecting the input corresponding to the request to move the text box to the second position, displaying, via the one or more display generation components, the text box and the second baseline; and
in response to detecting the input corresponding to the request to move the text box to the second position, ceasing display of the second baseline.

10. The method of claim 1, wherein the text box with the first set of one or more vertices includes a first set of one or more characters, the method further comprising:
while displaying the text box with the first set of one or more vertices:
in accordance with a determination that a third set of one or more criteria is satisfied, wherein the third set of one or more criteria includes a criterion that is satisfied when a font of the first set of one or more characters includes a first characteristic, displaying, via the one or more display generation components, a baseline at a first level within the text box; and
in accordance with a determination that a fourth set of one or more criteria, different from the third set of one or more criteria, is satisfied, wherein the fourth set of one or more criteria includes a second criterion that is satisfied when the font of the first set of one or more characters includes a second characteristic different from the first characteristic, displaying, via the one or more display generation components, the baseline at a second level, different from the first level, within the text box.

11. The method of claim 1, wherein display of the text box with the first set of one or more vertices includes display of a first set of one or more characters within the textbox with the first set of one or more vertices.

12. The method of claim 11, wherein display of the text box with the first set of one or more vertices includes display of a first character and a second character separate from the first character, wherein the second character is the same character as the first character, and wherein an orientation of the second character is different from an orientation of the first character.

13. The method of claim 11, wherein display of the text box with the first set of one or more vertices includes display of a third character and a fourth character separate from the fourth character, wherein the fourth character is the same character as the third character, and wherein an orientation of the fourth character is the same orientation as an orientation of the third character.

14. The method of claim 11, further comprising:
while detecting the input corresponding to the control point and in accordance with a determination that a fifth set of one or more criteria is satisfied, wherein the fifth set of one or more criteria includes a criterion that is satisfied when the input corresponding to the control point includes a third path different from the first path, ceasing display of, via the one or more display generation components, a first portion of the first set of one or more characters.

15. The method of claim 11, wherein the control point is a first control point, wherein the first set of one or more characters is displayed in a first orientation, the method further comprising:
while displaying, via the one or more display generation components, (1) the text box with the first set of one or more vertices, (2) the first control point, and (3) a second control point different from the first control point, detecting, via the one or more input devices, an input corresponding to a respective control point; and
in response to detecting the input corresponding to the respective control point:
in accordance with a determination that a sixth set of one or more criteria is satisfied, wherein the sixth set of one or more criteria includes a criterion that is satisfied when the respective control point is the first control point and that the input corresponding to the respective control point includes a fourth path moving toward a center of the text box with the first set of one or more vertices, ceasing display of, via the one or more display generation components, a first portion of the first set of one or more characters; and
in accordance with a determination that a seventh set of one or more criteria, different from the sixth set of one or more criteria, is satisfied, wherein the seventh set of one or more criteria includes a criterion that is satisfied when the respective control point is the second control point and that the input corresponding to the respective control point includes a fifth path different from a fifth path moving toward the center of the text box with the first set of one or more vertices, displaying, via the one or more display generation components, the first set of one or more characters with a second orientation different from the first orientation.

16. The method of claim 15, wherein ceasing display of the first portion of the first set of one or more characters includes:
in accordance with a determination that the first set of one or more characters includes less than a predefined number of characters, ceasing display of, via the one or more display generation components, a single character; and
in accordance with a determination that the first set of one or more characters includes more than the predefined number of characters, ceasing display of, via the one or more display generation components, a word.

17. The method of claim 15, further comprising:
in response to detecting the input corresponding to the respective control point and in accordance with a determination that the sixth set of one or more criteria is satisfied, displaying, via the one or more display generation components, a user interface element at a leading edge of the text box.

18. The method of claim 1, wherein display of the text box with the first set of one or more vertices includes display of a plurality of characters within the textbox with the first set of one or more vertices, wherein the first plurality of characters includes a first spacing between a first character of the plurality of characters and a second character of the plurality of characters, wherein the second character is separate from the first character, the method further comprising:
in response to detecting the input corresponding to the control point:
in accordance with a determination that an eighth set of one or more criteria is satisfied, wherein the eighth set of one or more criteria includes a criterion that is satisfied when the input corresponding to the control point includes a sixth path, displaying, via the one or more display components, the plurality of characters including the first spacing between the first character and the second character; and
in accordance with a determination that a ninth set of one or more criteria, different from the eighth criteria, is satisfied, wherein the ninth set of one or more criteria includes a criterion that is satisfied when the input corresponding to the control point includes the sixth path, displaying, via the one or more display components, the plurality of characters including a second spacing, different from the first spacing, between the first character and the second character.

19. The method of claim 1, wherein display of the text box with the first set of one or more vertices includes display of the text box with a first length, the method further comprising:
in response to detecting the input corresponding to the control point and in accordance with a determination that a tenth set of one or more criteria is satisfied, wherein the tenth set of one or more criteria includes a criterion that is satisfied when the input corresponding to the control point includes a seventh path moving away from the text box with the first set of one or more vertices, displaying, via the one or more display generation components, the text box with a second length longer than the first length without changing an orientation of the text box that was included in the text box before detecting the input corresponding to the control point.

20. The method of claim 1, further comprising:
while displaying the text box with the second set of one or more vertices, displaying, via the one or more display generation components, content;
while displaying the text box with the second set of one or more vertices and the content, detecting, via the input device, an input corresponding to a request to move the text box with the second set of one or more vertices; and
while detecting the input corresponding to the request to move the text box with the second set of one or more vertices:
in accordance with a determination that an eleventh set of one or more criteria is satisfied, wherein the eleventh set of one or more criteria includes a criterion that is satisfied when the input corresponding to the request to move the text box with the second set of one or more vertices is at a first location corresponding to the content, displaying, via the one or more display generation components, a first portion of the content with a first visual emphasis;
in accordance with a determination that a twelfth set of one or more criteria, different from the eleventh set of one or more criteria, is satisfied, wherein the twelfth set of one or more criteria includes a criterion that is satisfied when the input corresponding to the request to move the text box with the second set of one or more vertices is at a second location, different from the first location, corresponding to the content with the first shape, displaying, via the one or more display generation components, a second portion of the content, different from the first portion of the content, with the first visual emphasis.

21. The method of claim 20, further comprising:
after detecting the input corresponding to the request to move the text box with the second set of one or more vertices and in accordance with a determination that termination of the input corresponding to the request to move the text box with the second set of one or more vertices corresponds to the content, displaying, via the one or more display generation components, the text box wrapped along a path of the content.

22. The method of claim 21, wherein the text box is a first text box, wherein the path is a first path, the method further comprising:
while displaying the first text box wrapped along the first path of the content, detecting, via the one or more input devices, an input corresponding to a request to move a second text box different from the first text box; and
in response to detecting the input corresponding to the request to move the second text box and in accordance with a determination that termination of the input corresponding to the request to move the second text box corresponds to the content, displaying, via the one or more display generation components, the second text box wrapped along a second path, different from the first path, of the content while displaying the first text box wrapped along the first path of the content.

23. The method of claim 1, further comprising:
while displaying the text box with the second set of one or more vertices, detecting, via the one or more input devices, an input corresponding to a request to edit the text box with the second set of one or more vertices; and
in response to detecting the input corresponding to the request to edit the text box with the second set of one or more vertices, displaying, via the one or more display generation components, a first indication of a first vertex of the second set of one or more vertices and a second indication of a second vertex of the second set of one or more vertices with the text box with the second set of one or more vertices, wherein the second vertex is separate from the first vertex.

24. A non-transitory computer-readable storage medium storing one or more programs configured to be executed by one or more processors of a computer system that is in communication with one or more input devices and one or more display generation components, the one or more programs including instructions for:
while displaying, via the one or more display generation components, (1) a text box with a first set of one or more vertices and (2) a control point, detecting, via the one or more input devices, an input corresponding to the control point;
in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.

25. A computer system configured to communicate with one or more input devices and one or more display generation components, comprising:
one or more processors; and
memory storing one or more programs configured to be executed by the one or more processors, the one or more programs including instructions for:
while displaying, via the one or more display generation components, (1) a text box with a first set of one or more vertices and (2) a control point, detecting, via the one or more input devices, an input corresponding to the control point;
in response to detecting the input corresponding to the control point and in accordance with a determination that a first set of one or more criteria is satisfied, wherein the first set of one or more criteria includes a criterion that is satisfied when the input corresponding to the control point includes a first path, displaying, via the one or more display generation components, the text box with a second set of one or more vertices different from the first set of one or more vertices, wherein the second set of one or more vertices includes a different number of vertices than the first set of one or more vertices.
